(19) United States
(12) Patent Application Publication
(10) Pub. No.: US 2025/0059727 A1
(43) Pub. Date: Feb. 20, 2025

(54) WORKING MACHINE

(71) Applicant: KUBOTA CORPORATION, Osaka (JP)

(72) Inventor: Hiroya MORI, Osaka (JP)

(73) Assignee: KUBOTA CORPORATION, Osaka (JP)

(21) Appl. No.: 18/938,681

(22) Filed: Nov. 6, 2024

Related U.S. Application Data
(63) Continuation of application No. PCT/JP2023/017352, filed on May 9, 2023.

(30) Foreign Application Priority Data
May 12, 2022 (JP) 2022-078875

(51) Int. Cl. E02F 9/22; E02F 9/20; E02F 9/26; F15B 13/04; F15B 19/00

(52) U.S. Cl. CPC E02F 9/2203; E02F 9/2004; E02F 9/264; F15B 13/0401; F15B 19/00

(57) ABSTRACT

A working machine includes an arm, a working tool swingably attached to the arm, a working tool cylinder to swing the working tool by extending or retracting, one end portion of the working tool cylinder being supported on the arm via a cylinder shaft, the opposite end portion of the working tool cylinder being supported on the working tool, a cylinder sensor to detect an operation of the working tool cylinder, a control valve to extend or retract the working tool cylinder by controlling flow of a hydraulic fluid to the working tool cylinder, and a controller to periodically determine a swing position of the working tool based on an output value of the cylinder sensor, and the controller changes the accuracy of determining the swing position of the working tool in accordance with an operating status of the working tool cylinder.

### CROSS REFERENCE TO RELATED APPLICATIONS

This application is a continuation application of International Application No. PCT/JP2023/017352, filed on May 9, 2023, which claims the benefit of priority to Japanese Patent Application No. 2022-078875, filed on May 12, 2022. The entire contents of each of these applications are hereby incorporated herein by reference.

### BACKGROUND OF THE INVENTION

### 1. Field of the Invention

The present invention relates to working machines to perform work while swinging a working tool.

### 2. Description of the Related Art

A working machine disclosed in Japanese Unexamined Patent Application Publication No. 2021-4539 is known. The working machine disclosed in Japanese Unexamined Patent Application Publication No. 2021-4539 includes an arm, a working tool pivotally supported at a leading end of the arm in a swingable manner, a working tool cylinder for swinging the working tool, a control valve that controls flow of a hydraulic fluid to the working tool cylinder, and a controller that determines a swing position of the working tool based on a swing angle of the working tool cylinder about a cylinder shaft.

### SUMMARY OF THE INVENTION

In a working machine like the one disclosed in Japanese Unexamined Patent Application Publication No. 2021-4539, in response to operation of a manual operator, an opening of a control valve changes, and a path and a flow rate of a hydraulic fluid flowing from the control valve to a working tool cylinder change, and thereby the working tool cylinder operates and a working tool swings. However, for example, in a case where an operation amount of the manual operator is small and the opening of the control valve is small, a hydraulic pressure acting on the working tool cylinder is low, and therefore the working tool cylinder and the working tool sometimes rattle due to external force by an amount corresponding to looseness occurring in a support portion for the working tool cylinder or the working tool. In this case, an output signal from an angle sensor that detects a swing angle of the working tool cylinder irregularly changes, and therefore undesirably a controller may erroneously determine a swing position of the working tool.

One way to address this is to increase the accuracy of determining the swing position, for example, by increasing the number of sampled output signals of the angle sensor used to determine the swing position of the working tool. However, in this case, it takes time to determine the swing position of the working tool, and it may be impossible to properly determine the swing position of the working tool while following an operating speed of the working tool.

Example embodiments of the present invention make it possible to appropriately determine the swing position of a working tool depending on the state of the working tool.

A working machine according to an aspect of an example embodiment of the present invention includes: an arm; a working tool swingably attached to the arm; a working tool cylinder to swing the working tool by extending or retracting, one end portion of the working tool cylinder being supported on the arm via a cylinder shaft, an opposite end portion of the working tool cylinder being supported on the working tool; a cylinder sensor to detect an operation of the working tool cylinder; a control valve to extend or retract the working tool cylinder by controlling a flow of hydraulic fluid to the working tool cylinder; and a controller configured or programmed to periodically determine a swing position of the working tool based on an output value of the cylinder sensor, wherein the controller is configured or programmed to change an accuracy of determining the swing position of the working tool in accordance with an operating status of the working tool cylinder.

The control valve may be switchable between a first position to retract the working tool cylinder, a second position to extend the working tool cylinder, and a third position to not extend or retract the working tool cylinder. The controller may be configured or programmed to, when the control valve is in the first position or the second position, cause the accuracy of determining the swing position of the working tool to be higher than a predetermined determination accuracy for normal times until a predetermined condition is satisfied.

The working machine may further include a manual operator to control a swing of the working tool cylinder. The controller may be configured or programmed to, after the manual operator starts to be operated and when the control valve is in the first position or the second position, cause the accuracy of determining the swing position of the working tool to be higher than the determination accuracy for normal times if an operation amount of the manual operator is less than a predetermined threshold, and set the accuracy of determining the swing position of the working tool to the determination accuracy for normal times if the operation amount is equal to or larger than the threshold.

The working machine may further include a solenoid to actuate the control valve in accordance with a supplied control current. The controller may be configured or programmed to, when the control valve is in the first position or the second position, cause the accuracy of determining the swing position of the working tool to be higher than the determination accuracy for normal times if a control current value, which is a current value of the control current supplied to the solenoid, is less than a predetermined threshold, and set the accuracy of determining the swing position of the working tool to the determination accuracy for normal times if the control current value is equal to or larger than the threshold.

The working machine may further include a flow rate sensor to measure a flow rate of hydraulic fluid flowing from the control valve to the working tool cylinder. The controller may be configured or programmed to, when the control valve is in the first position or the second position, cause the accuracy of determining the swing position of the working tool to be higher than the determination accuracy for normal times if the flow rate of hydraulic fluid measured by the flow rate sensor is less than a predetermined threshold, and set the accuracy of determining the swing position of the working tool to the determination accuracy for normal times if the flow rate of hydraulic fluid is equal to or higher than the threshold.

The working machine may further include a pressure sensor to measure a hydraulic pressure of hydraulic fluid that acts from the control valve on the working tool cylinder. The controller may be configured or programmed to, when the control valve is in the first position or the second position, cause the accuracy of determining the swing position of the working tool to be higher than the determination accuracy for normal times if the hydraulic pressure of hydraulic fluid measured by the pressure sensor is less than a predetermined threshold, and set the accuracy of determining the swing position of the working tool to the determination accuracy for normal times if the hydraulic pressure of hydraulic fluid is equal to or higher than the threshold.

The controller may be configured or programmed to change the accuracy of determining the swing position of the working tool by changing the number of sampled output values of the cylinder sensor used to determine the swing position of the working tool.

The controller may be configured or programmed to change the number of sampled output values of the cylinder sensor by changing at least one of a sampling time or a sampling cycle during or at which the output value of the cylinder sensor used to determine the swing position of the working tool is sampled.

The working machine may further include a machine body to support the arm, the cylinder sensor may include an angle sensor to detect (i) a swing angle of the working tool cylinder when the working tool is in a range farther away from the machine body than a neutral position of the working tool and (ii) a swing angle of the working tool cylinder when the working tool is in a range closer to the machine body than the neutral position of the working tool, the neutral position of the working tool being a position in which the swing angle of the working tool cylinder about the cylinder shaft is maximum. The controller may be configured or programmed to determine the swing position of the working tool based on a change trend of an output value of the angle sensor, a direction of extension or retraction of the working tool cylinder, and the swing angle of the working tool cylinder detected based on the output value of the angle sensor.

The controller may be configured or programmed to determine that the output value of the angle sensor shows an increasing trend if the output value has increased continuously for a predetermined period, determine that the output value of the angle sensor shows a decreasing trend if the output value has decreased continuously for the predetermined period, and change the predetermined period in accordance with the operating status of the working tool cylinder.

The controller may be configured or programmed to determine that the output value of the angle sensor shows an increasing trend if the output value has increased sequentially a predetermined number of times of sampling, determine that the output value of the angle sensor shows a decreasing trend if the output value has decreased sequentially the predetermined number of times of sampling, and change the predetermined number of times of sampling in accordance with the operating status of the working tool cylinder.

The working machine may further include a manual operator to control a swing of the working tool. The controller may be configured or programmed to determine the direction in which the working tool cylinder is actuated, based on an operation state of the manual operator.

The working machine may further include a solenoid to actuate the control valve in accordance with a supplied control current. The controller may be configured or programmed to determine the direction in which the working tool cylinder is actuated, based on a control current value which is a current value of the control current supplied to the solenoid.

The working machine may further include a memory and/or a storage to store setting information relating to the predetermined condition in a changeable manner. The controller may be configured or programmed to decide the predetermined condition in accordance with the setting information stored in the memory and/or the storage.

The working machine may further include a manual operator to control a swing of the working tool. The setting information may include a threshold unique to the working machine and to be compared with a physical quantity which changes as the manual operator is operated, the physical quantity being included in the predetermined condition based on which the accuracy of determining the swing position of the working tool is changed.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a side view of a working machine.

FIG. 2 is a side view illustrating action of a bucket.

FIG. 3 is a side view illustrating action of a bucket cylinder.

FIG. 4 is a configuration diagram of an example of a bucket control system of the working machine.

FIG. 5 is a time chart illustrating an example of operation of the bucket control system of the working machine.

FIG. 6 is a flowchart illustrating an example of operation of the bucket control system of the working machine.

FIG. 7A is a flowchart illustrating an example of details of a bucket position determining process of FIG. 6.

FIG. 7B is a flowchart of continuation of FIG. 7A.

FIG. 8 is a flowchart illustrating another example of details of the bucket position determining process of FIG. 6.

FIG. 9 is a time chart illustrating another example of operation of the bucket control system of the working machine.

FIG. 10 is a cross-sectional view of the bucket cylinder.

FIG. 11A illustrates a fully extended state of the bucket cylinder.

FIG. 11B illustrates an extension/retraction state in a state where the bucket cylinder is at a reversal position.

FIG. 11C illustrates a fully retracted state of the bucket cylinder.

FIG. 12 is a configuration diagram of another example of the bucket control system of the working machine.

FIG. 13 is a configuration diagram of another example of the bucket control system of the working machine.

FIG. 14 is a configuration diagram of another example of the bucket control system of the working machine.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

Example embodiments of the present invention are described below while referring to the drawings as appropriate.

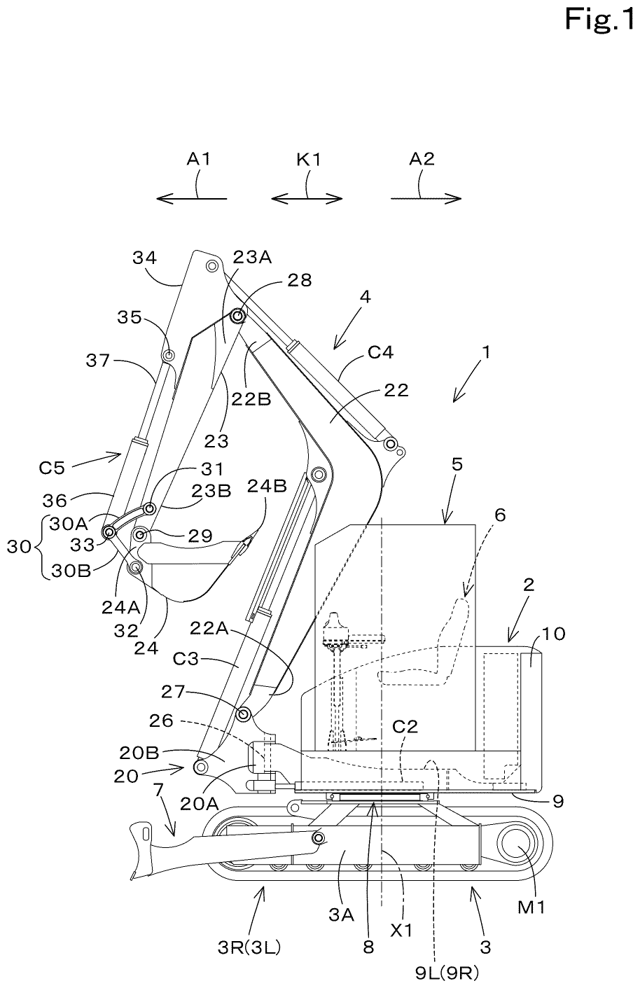

FIG. 1 is a side view illustrating a whole working machine 1 according to the present example embodiment. In the present example embodiment, a backhoe (digging working machine) is illustrated as the working machine 1. The working machine according to the present invention may be a working machine other than a backhoe.

As illustrated in FIG. 1, the working machine 1 includes a machine body 2, a traveling device 3, and a working device 4. A cabin 5 is mounted above the machine body 2. In the cabin 5, an operator's seat 6 on which a driver (operator) sits is provided.

In the present example embodiment, a direction (a direction indicated by arrow A1 in FIG. 1) in which the working device 4 is provided relative to the machine body 2 of the working machine 1 is referred to as a forward direction, a direction (a direction indicated by arrow A2 in FIG. 1) opposite to the forward direction is referred to as a rearward direction, a left side as viewed from the operator facing forward (a near side in FIG. 1) is referred to as a leftward direction, and a right side as viewed from the operator facing forward (a far side in FIG. 1) is referred to as a rightward direction. Furthermore, a horizontal direction orthogonal to a front-rear direction (machine body front-rear direction) K1 illustrated in FIG. 1 is referred to as a machine body width direction. A direction pointing rightward or leftward from a central portion in the machine body width direction is referred to as an outward direction in the machine body width direction, and a direction opposite to the outward direction in the machine body width direction is referred to as an inward direction in the machine body width direction.

The traveling device 3 supports the machine body 2 so that the machine body 2 can travel. The traveling device 3 includes a first traveling mechanism 3L provided on a left portion of a traveling frame 3A and a second traveling mechanism 3R provided on a right portion of the traveling frame 3A. The first traveling mechanism 3L and the second traveling mechanism 3R are crawler-type traveling mechanisms. The first traveling mechanism 3L is driven by a left traveling motor M1 provided on a left portion of the traveling frame 3A, and the second traveling mechanism 3R is driven by a right traveling motor M1 provided on a right portion of the traveling frame 3A. The traveling motors M1 are, for example, hydraulic motors (hydraulic actuators).

A dozer device 7 is mounted on a front portion of the traveling device 3. The dozer device 7 can be raised and lowered (a blade can be raised and lowered) by extending and retracting a dozer cylinder (hydraulic actuator).

The machine body 2 is supported on the traveling frame 3A with a swivel bearing 8 interposed therebetween so as to be capable of swiveling about a swivel axis X1. The swivel axis X1 is an axis passing a center of the swivel bearing 8 and extends in an up-down direction. A prime mover (not illustrated) is mounted on the machine body 2. The prime mover is, for example, a diesel engine. Note that the prime mover may be a gasoline engine or an electric motor. The working machine 1 may be a hybrid working machine including an engine and an electric motor as a prime mover.

The machine body 2 includes a swivel board 9 that swivels about the swivel axis X1. The swivel board 9 is formed from a steel plate or the like and constitutes a bottom portion of the machine body 2. On a central portion of an upper surface of the swivel board 9, longitudinal ribs 9L and 9R (reinforcing members) are provided so as to extend from a front portion to a rear portion of the swivel board 9. A weight 10 is provided in a rear portion of the machine body 2. The weight 10 stands on the swivel board 9.

A support body 20 that supports the working device 4 is provided on a front portion of the machine body 2. The support body 20 includes a support bracket 20A and a swing bracket 20B. The support bracket 20A is fixed to front portions of the longitudinal ribs 9L and 9R and protrudes forward from the machine body 2. The swing bracket 20B is attached to a front portion (a portion protruding from the machine body 2) of the support bracket 20A with the use of a swing shaft 26 so as to be swingable about a vertical axis (an axis extending in the up-down direction). This allows the swing bracket 20B to rotate in the machine body width direction (in a horizontal direction about the swing shaft 26). Accordingly, the working device 4 can rotate about the swing shaft 26.

The working device 4 is attached to the swing bracket 20B. The working device 4 includes a boom 22, an arm 23, and a bucket (working tool) 24. A base portion 22A of the boom 22 is pivotally supported (rotatably supported) on an upper portion of the swing bracket 20B with the use of a boom shaft 27. The boom shaft 27 has a shaft center extending in the machine body width direction. The boom 22 swings in the up-down direction by rotating about the boom shaft 27.

A base end portion 23A of the arm 23 is pivotally supported on a leading end portion 22B of the boom 22 with the use of an arm shaft 28. A shaft center of the arm shaft 28 is parallel to the shaft center of the boom shaft 27. Accordingly, the arm 23 rotates about the arm shaft 28. By rotating about the arm shaft 28, the arm 23 swings back and forth, and a leading end portion 23B moves toward and away from the boom 22 and the machine body 2.

A base portion 24A of the bucket 24 is pivotally supported on the leading end portion 23B of the arm 23 with the use of a bucket shaft (working tool shaft) 29. A shaft center of the bucket shaft 29 is parallel to the shaft center of the arm shaft 28. The bucket 24 can rotate about the bucket shaft 29. By rotating about the bucket shaft 29, the bucket 24 swings back and forth, and a leading end portion 24B moves toward and away from the boom 22 and the machine body 2.

In the present example embodiment, a swing direction in which the arm 23 and the bucket 24 move toward the boom 22 and the machine body 2 is referred to as a shovel direction, and a swing direction in which the arm 23 and the bucket 24 move away from the boom 22 and the machine body 2 is referred to as a dump direction. That is, the bucket 24 can perform a shoveling action and a dumping action. Note that the shoveling action is an action of scooping dirt or the like by moving the bucket 24 toward the boom 22 and the machine body 2. The dumping action is an action of dropping (discharging) dirt or the like in the bucket 24 by moving the bucket 24 away from the boom 22 and the machine body 2.

The bucket 24 is coupled to the arm 23 by a link mechanism 30. The link mechanism 30 includes a first link 30A and a second link 30B. One end of the first link 30A is pivotally supported on the arm 23 with the use of a first link shaft 31. One end of the second link 30B is pivotally supported on the base portion 24A of the bucket 24 with the use of a second link shaft 32. The other end of the first link 30A and the other end of the second link 30B are pivotally supported on each other with the use of a coupling shaft 33. Shaft centers of the first link shaft 31, the second link shaft 32, and the coupling shaft 33 are parallel to the shaft center of the bucket shaft 29.

Although the bucket 24 is attached to the working machine 1 as a working tool in the present example embodiment, another working tool (hydraulic attachment) that can be driven by a hydraulic actuator can be attached instead of or in addition to the bucket 24. Examples of such a working tool include a hydraulic breaker, a hydraulic crusher, an angle broom, an earth auger, a pallet fork, a sweeper, a mower, and a snow blower.

The swing bracket 20B can swing as a swing cylinder C2 provided in the machine body 2 extends and retracts. The boom 22 can swing as a boom cylinder C3 extends and retracts. The arm 23 can swing as an arm cylinder C4 extends and retracts. The bucket 24 can swing as a bucket cylinder C5 extends and retracts. These cylinders C2, C3, C4, and C5 are double-acting hydraulic cylinders (hydraulic actuators).

The bucket cylinder C5 is provided forward of the arm 23. Furthermore, the bucket cylinder C5 is provided along the arm 23. One end portion of the bucket cylinder C5 is pivotally supported on the base end portion 23A of the arm 23. Specifically, the one end portion of the bucket cylinder C5 is pivotally supported on a bracket 34 fixed to the base end portion 23A of the arm 23 with the use of a cylinder shaft 35. A shaft center of the cylinder shaft 35 is parallel to the shaft center of the arm shaft 28. The opposite end portion of the bucket cylinder C5 is pivotally supported on the other ends of the first link 30A and the second link 30B with the use of the coupling shaft 33.

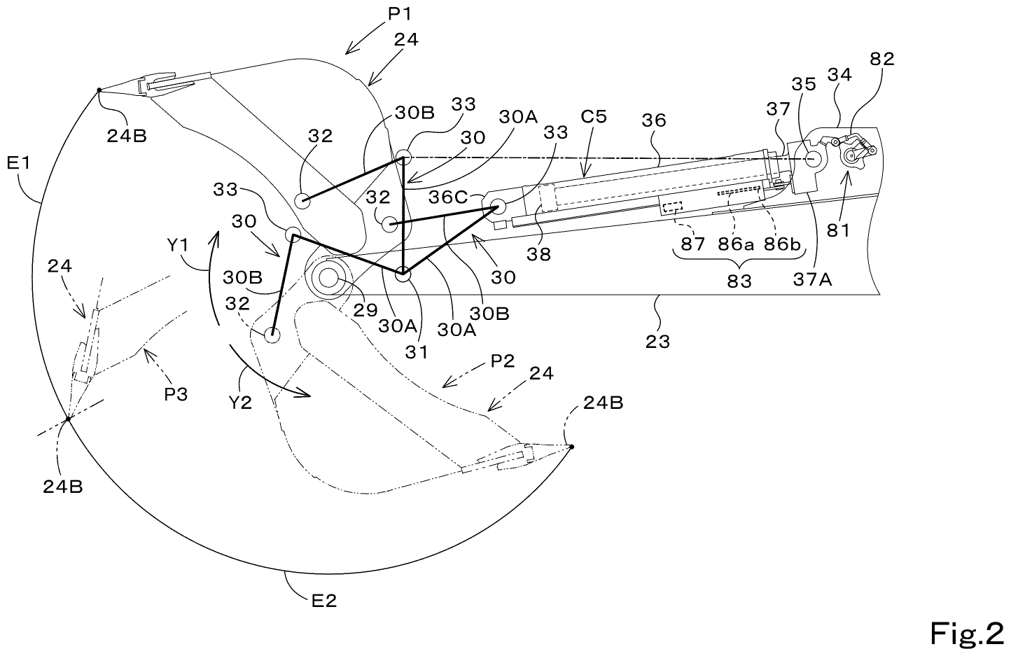

FIG. 2 is a side view illustrating action of the bucket 24. The bucket cylinder C5 includes a cylinder tube 36, a rod 37, and a piston 38. The piston 38 is stored in the cylinder tube 36. The piston 38 is movable in an axial direction of the cylinder tube 36. A base end portion of the rod 37 is coupled to the piston 38 in the cylinder tube 36. When the piston 38 moves in the axial direction of the cylinder tube 36, the rod 37 protrudes and retracts with respect to the cylinder tube 36, and the bucket cylinder C5 extends and retracts.

A head 37A is provided at a leading end portion of the rod 37. The head 37A is pivotally supported on the bracket 34 with the use of the cylinder shaft 35. An attachment unit 36C is provided at an end portion of the cylinder tube 36 on a bottom side (a side where the piston 38 is present with respect to the head 37A). The attachment unit 36C is pivotally supported on the other ends of the first link 30A and the second link 30B with the use of the coupling shaft 33.

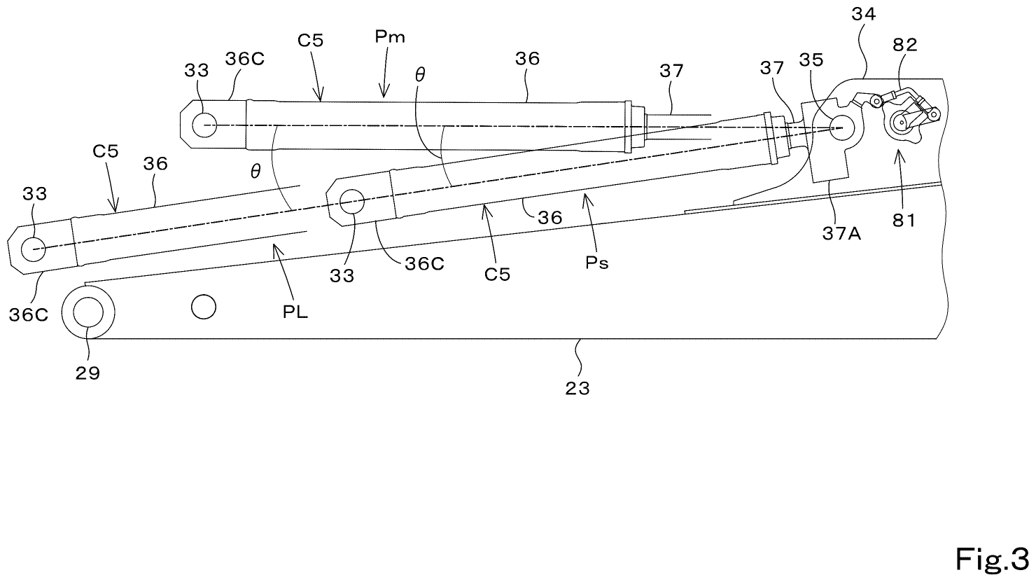

FIG. 3 is a side view illustrating action of the bucket cylinder C5. As illustrated in FIG. 3, the bucket cylinder C5 extends and retracts and thereby swings about the cylinder shaft 35. In accordance with this action (extension/retraction and swing) of the bucket cylinder C5, the bucket 24 swings in a dump direction Y1 or a shovel direction Y2 about the bucket shaft 29, as illustrated in FIG. 2.

The bucket 24 swings between a dump end position P1 where the leading end portion 24B is farthest from the arm 23 as indicated by the solid line in FIG. 2 and a shovel end position P2 where the leading end portion 24B is closest to the arm 23 as indicated by the line with alternate long and two short dashes by swinging about the bucket shaft 29. The dump end position P1 is a terminal end position in the dump direction Y1 where the bucket 24 is located when the bucket cylinder C5 is retracted fully (a fully retracted position Ps illustrated in FIG. 3). The shovel end position P2 is a terminal end position in the shovel direction Y2 where the bucket 24 is located when the bucket cylinder C5 is extended fully (a fully extended position PL illustrated in FIG. 3).

As illustrated in FIG. 3, the bucket cylinder C5 is parallel to the arm 23 when the bucket cylinder C5 is at the fully retracted position Ps and when the bucket cylinder C5 is at the fully extended position PL. As the bucket cylinder C5 located at the fully retracted position Ps extends, the bucket cylinder C5 swings so as to move away from the arm 23 for a while, and a swing angle of the bucket cylinder C5 gradually increases. Then, as the bucket cylinder C5 further extends, the swing direction of the bucket cylinder C5 is reversed at a midway reversal position Pm, the bucket cylinder C5 swings so as to move toward the arm 23, and the swing angle of the bucket cylinder C5 gradually decreases.

The swing angle of the bucket cylinder C5 is minimum (e.g., 0°) when the bucket cylinder C5 is at the fully retracted position Ps and when the bucket cylinder C5 is at the fully extended position PL. The swing angle of the bucket cylinder C5 is maximum when the bucket cylinder C5 is at the reversal position Pm. The swing direction and increase/decrease trend of the swing angle of the bucket cylinder C5 are reversed at the reversal position Pm.

When the bucket cylinder C5 is at the reversal position Pm, the bucket 24 is located at a neutral position P3 illustrated in FIG. 2. When the bucket cylinder C5 swings while retracting from the reversal position Pm toward the fully retracted position Ps, the bucket 24 swings so as to move away from the arm 23 (and the machine body 2) (dumping action). When the bucket cylinder C5 swings while extending from the reversal position Pm toward the fully extended position PL, the bucket 24 swings so as to move toward the arm 23 (and the machine body 2) (shoveling action).

The reversal position Pm of the bucket cylinder C5 and the neutral position P3 of the bucket 24 are conceptual positions. As illustrated in FIG. 2, the bucket 24 is swingable to a dump range E1 farther away from the machine body 2 and to a shovel range E2 closer to the machine body 2, and the neutral position P3 corresponding to the reversal position Pm of the bucket cylinder C5 serves as a boundary.

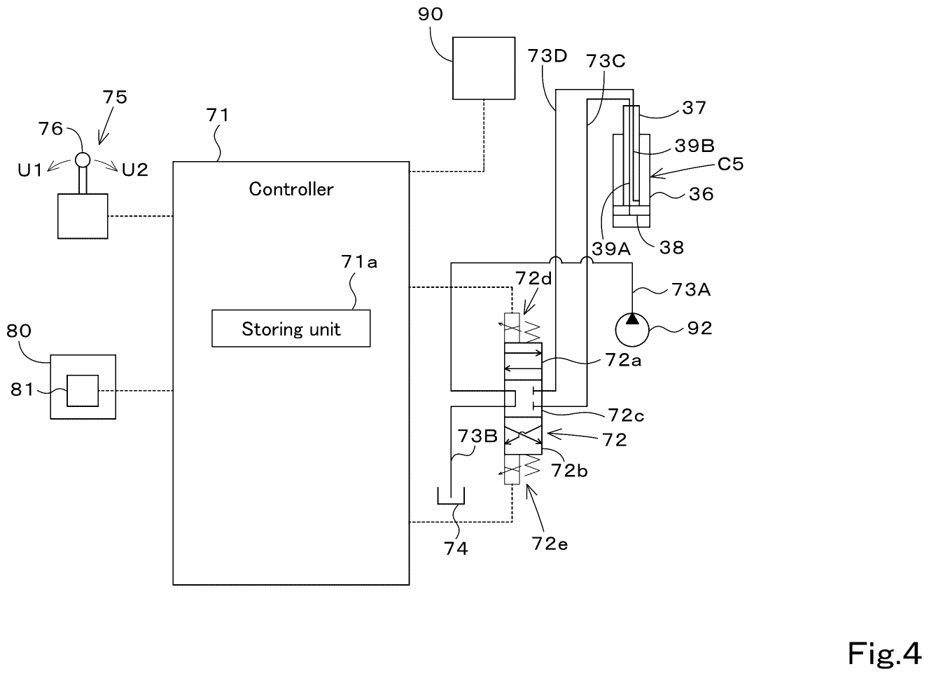

FIG. 4 is a schematic configuration diagram of an example of a bucket control system included in the working machine 1. The bucket control system is a system for controlling action (swing) of the bucket 24.

A controller 71 is a controller of the bucket control system and is, for example, a microcomputer including a CPU, a volatile memory, a nonvolatile memory, and the like. A storing unit (memory and/or storage) 71a provided in the controller 71 is a nonvolatile memory. In the storing unit 71a, control data used by the controller 71 to control each unit is stored in a readable and writable manner. The storing unit 71a is an example of a memory. In another example, a memory separate from the controller 71 may be provided in the working machine 1. To the controller 71, a bucket control valve 72, an operation device 75, a cylinder sensor 80, and a display 90 are electrically connected.

The bucket control valve 72 is a control valve that controls flow (a supply amount and a supply direction) of a hydraulic fluid to the bucket cylinder C5. The bucket control valve 72 is, for example, an electromagnetic proportional valve. The bucket control valve 72 is switchable between a first position 72a, a second position 72b, and a third position (neutral position) 72c. The controller 71 electrically controls a switch position and an opening area of the bucket control valve 72.

The bucket control valve 72 is connected to a hydraulic pump 92 by a delivery fluid passage 73A. The bucket control valve 72 is connected to a tank 74 by a discharge fluid passage 73B. The bucket control valve 72 is connected to the rod 37 of the bucket cylinder C5 by a first supply fluid passage 73C and a second supply fluid passage 73D. In the rod 37, a first fluid passage 39A and a second fluid passage 39B are provided. An inside of the cylinder tube 36 is partitioned into a first pressure chamber 36A and a second pressure chamber 36B by the piston 38. The first supply fluid passage 73C, the first fluid passage 39A, and the first pressure chamber 36A communicate with one another. The second supply fluid passage 73D, the second fluid passage 39B, and the second pressure chamber 36B communicate with one another.

The bucket control valve 72 includes a first solenoid 72d and a second solenoid 72e. The first solenoid 72d and the second solenoid 72e are energized upon input of a current signal from the controller 71 and are deenergized when the current signal ceases to be input from the controller 71.

While the first solenoid 72d and the second solenoid 72e are being deenergized, the bucket control valve 72 is at the third position (neutral position) 72c, and a hydraulic fluid delivered from the hydraulic pump 92 to the delivery fluid passage 73A is discharged to the tank 74 by passing an inside of the third position 72c of the bucket control valve 72 and the discharge fluid passage 73B. In this case, the hydraulic fluid does not flow from the bucket control valve 72 to the bucket cylinder C5 through the supply fluid passages 73C and 73D, and therefore the bucket cylinder C5 does not extend/retract nor swing, and the bucket 24 does not swing.

When the first solenoid 72d is energized and the second solenoid 72e is deenergized, a spool of the bucket control valve 72 moves, and the bucket control valve 72 switches to the first position 72a. This allows the hydraulic fluid delivered from the hydraulic pump 92 to the delivery fluid passage 73A to flow into the second pressure chamber 36B of the bucket cylinder C5 by passing an inside of the first position 72a of the bucket control valve 72, the second supply fluid passage 73D, and the second fluid passage 39B and press the piston 38 toward the bottom side of the cylinder tube 36. Then, the hydraulic fluid in the first pressure chamber 36A is discharged to the tank 74 by passing the first fluid passage 39A, the first supply fluid passage 73C, the inside of the first position 72a of the bucket control valve 72, and the discharge fluid passage 73B. Accordingly, the piston 38 and the rod 37 of the bucket cylinder C5 move toward the bottom side of the cylinder tube 36, an amount by which the rod 37 protrudes from the cylinder tube 36 decreases, the bucket cylinder C5 swings while retracting, and the bucket 24 swings in the dump direction Y1.

When the second solenoid 72e is energized and the first solenoid 72d is deenergized, the spool of the bucket control valve 72 moves, and the bucket control valve 72 switches to the second position 72b. This allows the hydraulic fluid delivered from the hydraulic pump 92 to the delivery fluid passage 73A to flow into the first pressure chamber 36A of the bucket cylinder C5 by passing an inside of the second position 72b of the bucket control valve 72, the first supply fluid passage 73C, and the first fluid passage 39A and press the piston 38 toward the rod side of the cylinder tube 36. Then, the hydraulic fluid in the second pressure chamber 36B is discharged to the tank 74 by passing the second fluid passage 39B, the second supply fluid passage 73D, the inside of the second position 72b of the bucket control valve 72, and the discharge fluid passage 73B. Accordingly, the piston 38 and the rod 37 of the bucket cylinder C5 move toward the rod side of the cylinder tube 36, an amount by which the rod 37 protrudes from the cylinder tube 36 increases, the bucket cylinder C5 swings while extending, and the bucket 24 swings in the shovel direction Y2.

Note that when the bucket control valve 72 is switched to the first position 72a, the opening area of the first position 72a increases (opening increases), a flow rate of a hydraulic fluid output from the bucket control valve 72 to the bucket cylinder C5 through the second supply fluid passage 73D increases, and the hydraulic pressure of the hydraulic fluid increases as a current value of the current signal input from the controller 71 to the first solenoid 72d increases. When the bucket control valve 72 is switched to the second position 72b, the opening area of the second position 72b increases (opening increases), a flow rate of a hydraulic fluid output from the bucket control valve 72 to the bucket cylinder C5 through the first supply fluid passage 73C increases, and the hydraulic pressure of the hydraulic fluid increases as a current value of the current signal input from the controller 71 to the second solenoid 72e increases.

The operation device 75 includes an operating lever (manual operator) 76 for operating the bucket 24 and a sensor (potentiometer, not illustrated) that detects an operation amount (swing angle) of the operating lever 76. The operating lever 76 is operated by an operator sitting on the operator's seat 6 (FIG. 1).

When first operation is performed on the operating lever 76 to tilt the operating lever 76 in a first direction U1 from the neutral position, a first operation signal (voltage signal) according to an operation amount (tilt angle) is output from the operation device 75 to the controller 71. Upon start of input of the first operation signal, the controller 71 periodically samples (detects) a voltage value of the first operation signal. Then, the controller 71 determines an operation direction and an operation amount of the operating lever 76 in accordance with a plurality of voltage values of the first operation signal thus sampled and supplies a control signal (current signal) according to the operation amount to the first solenoid 72d according to the operation direction (the first direction U1 in this case) to energize the first solenoid 72d. The controller 71 thus switches the bucket control valve 72 to the first position 72a and changes the opening of the first position 72a. That is, the first operation of the operating lever 76 is operation for moving the bucket 24 in the dump direction Y1 (FIG. 2).

When second operation is performed on the operating lever 76 to tilt the operating lever 76 in a second direction U2 (FIG. 4) from the neutral position, a second operation signal (voltage signal) according to an operation amount (tilt angle) is output from the operation device 75 to the controller 71. Upon start of input of the second operation signal, the controller 71 periodically samples (detects) a voltage value of the second operation signal. Then, the controller 71 determines an operation direction and an operation amount of the operating lever 76 in accordance with a plurality of voltage values of the second operation signal thus sampled, and supplies a control signal (current signal) according to the operation amount to the second solenoid 72e according to the operation direction (the second direction U2 in this case) to energize the second solenoid 72e. The controller 71 thus switches the bucket control valve 72 to the second position 72b and changes the opening of the second position 72b. The second operation of the operating lever 76 is operation for moving the bucket 24 in the shovel direction Y2 (FIG. 2).

When the operating lever 76 is operated to return to the neutral position, a third operation signal according to the operation is output from the operation device 75. The controller 71 returns the bucket control valve 72 to the third position 72c in accordance with the third operation signal. In another example, when the operating lever 76 is returned to the neutral position, output of an operation signal from the operation device 75 may be stopped, and the controller 71 may return the bucket control valve 72 to the third position 72c in accordance with the absence of an operation signal.

Another manual operator such as a joystick may be provided in the operation device 75 instead of the operating lever 76. In this case, the operation device 75 need just include an electric circuit that outputs an operation signal (electric signal) according to an operation direction and an operation amount of the joystick.

The cylinder sensor 80 detects operation of the bucket cylinder C5. The cylinder sensor 80 includes an angle sensor 81. The angle sensor 81 is, for example, a potentiometer and detects the swing of the bucket cylinder C5. The angle sensor 81 detects a swing angle of the bucket cylinder C5 when the bucket 24 is in the dump range E1 (FIG. 2) farther away from the arm 23 and the machine body 2 than the neutral position P3 of the bucket 24 in which the swing angle of the bucket cylinder C5 about the cylinder shaft 35 is maximum. Furthermore, the angle sensor 81 detects the swing angle of the bucket cylinder C5 when the bucket 24 is in the shovel range E2 (FIG. 2) closer to the arm 23 and the machine body 2 than the neutral position P3.

As illustrated in FIG. 3 and other drawings, the angle sensor 81 is coupled to the head 37A of the rod 37 of the bucket cylinder C5 by an interlocking link 82. The angle sensor 81 detects, as the swing angle of the bucket cylinder C5, a rotation angle of the head 37A about the cylinder shaft 35 through the interlocking link 82. Note that the angle sensor 81 may directly detect, as the swing angle, the rotation angle of the bucket cylinder C5 about the cylinder shaft 35.

The angle sensor 81 outputs an electric signal (voltage signal) according to the swing angle of the bucket cylinder C5 to the controller 71. In the present example embodiment, the swing angle of the bucket cylinder C5 is minimum and a voltage value of the output signal from the angle sensor 81 is also minimum when the bucket cylinder C5 is at the fully retracted position Ps and when the bucket cylinder C5 is at the fully extended position PL. As the bucket cylinder C5 extends and the swing angle of the bucket cylinder C5 increases, the voltage value of the output signal from the angle sensor 81 increases. The swing angle of the bucket cylinder C5 is maximum and the voltage value of the output signal from the angle sensor 81 is also maximum when the bucket cylinder C5 is at the reversal position Pm.

The controller 71 periodically detects the voltage value of the output signal from the angle sensor 81 as an output value (potentiometer value) of the angle sensor 81. Then, the controller 71 periodically determines the swing position of the bucket 24 based on a plurality of output values of the angle sensor 81. The controller 71 causes a result of determination of the swing position of the bucket 24 to be stored in the storing unit 71a. Furthermore, the controller 71 may cause the result of determination of the swing position of the bucket 24 to be displayed on the display 90.

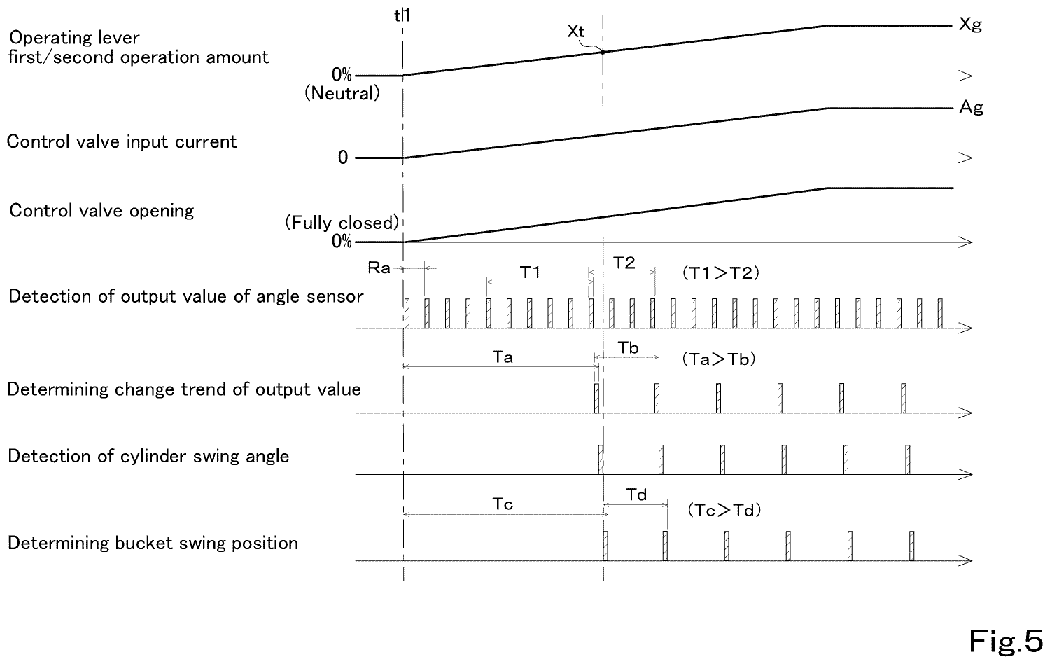

FIG. 5 is a time chart of the bucket control system of the working machine 1. In FIG. 5, “Operation lever first/second operation amount” means an operation amount of the first operation (operation in the first direction U1 in FIG. 4) or the second operation (operation in the second direction U2 in FIG. 4) of the operating lever 76. “Control valve input current” means a value of a current flowing from the controller 71 to the solenoid 72d or 72e of the bucket control valve 72. “Control valve opening” means an opening of an opening portion (output port) of the first position 72a or the second position 72b of the bucket control valve 72. “Angle sensor output value detection”, “Output value change trend determination”, “Cylinder swing angle detection”, and “Bucket swing position determination” mean operation executed by the controller 71 (CPU).

In the bucket control system of the working machine 1, when the first operation or the second operation of the operating lever 76 is performed, the controller 71 determines an operation state (an operation direction and an operation amount) of the operating lever 76, switches the bucket control valve 72 from the third position 72c to the first position 72a or the second position 72b in accordance with the operation state, extends/retracts and swings the bucket cylinder C5, and swings the bucket 24 in the dump direction Y1 or the shovel direction Y2. In this case, the controller 71 increases a current value of a control current supplied to the first solenoid 72d or the second solenoid 72e (“Control valve input current”) and increases the opening of the first position 72a or the second position 72b of the bucket control valve 72 (“Control valve opening”) as the operation amount of the operating lever 76 increases (“Operation lever first/second operation amount” in FIG. 5).

In this case, it is necessary to prevent the bucket 24 from rapidly swinging markedly and prevent or reduce variations of a working state of the bucket control valve 72, the bucket cylinder C5, or the bucket 24 depending on a condition (e.g., temperature) of a surrounding environment. Accordingly, the controller 71 sets the current supplied to the first solenoid 72d or the second solenoid 72e corresponding to the first operation or the second operation of the operating lever 76 to a value according to the increase of the first operation amount or the second operation amount of the operating lever 76 by gradually increasing the current from a low value to a large value (“Control valve input current”). In this way, the opening of the first position 72a or the second position 72b of the bucket control valve 72 corresponding to the first operation or the second operation of the operating lever 76 gradually increases (“Control valve opening”).

For some time immediately after operation start t1 of the first operation or the second operation of the operating lever 76, the operation amount of the operating lever 76 is small, an input current value input (supplied) from the controller 71 to the corresponding solenoid 72d or 72e is low, the opening of the bucket control valve 72 is small, and a sufficiently high hydraulic pressure does not act on the bucket cylinder C5. In this case, the bucket cylinder C5 and the bucket 24 sometimes rattle upon application of external force due to looseness occurring in a support portion for the bucket cylinder C5 and a support portion for the bucket 24. Similarly, in a case where an operation amount at a time when the first operation or the second operation of the operating lever 76 is stopped is too small, a sufficiently high hydraulic pressure does not act on the bucket cylinder C5, and the bucket cylinder C5 and the bucket 24 sometimes rattle.

In this case, the output value (voltage value) of the angle sensor 81 that detects the swing angle of the bucket cylinder C5 irregularly fluctuates, and therefore undesirably the controller 71 may erroneously determine the swing position of the bucket 24 based on the output value. To address this, the controller 71 changes the accuracy of determining the swing position of the bucket 24 in accordance with the operating status of the bucket cylinder C5.

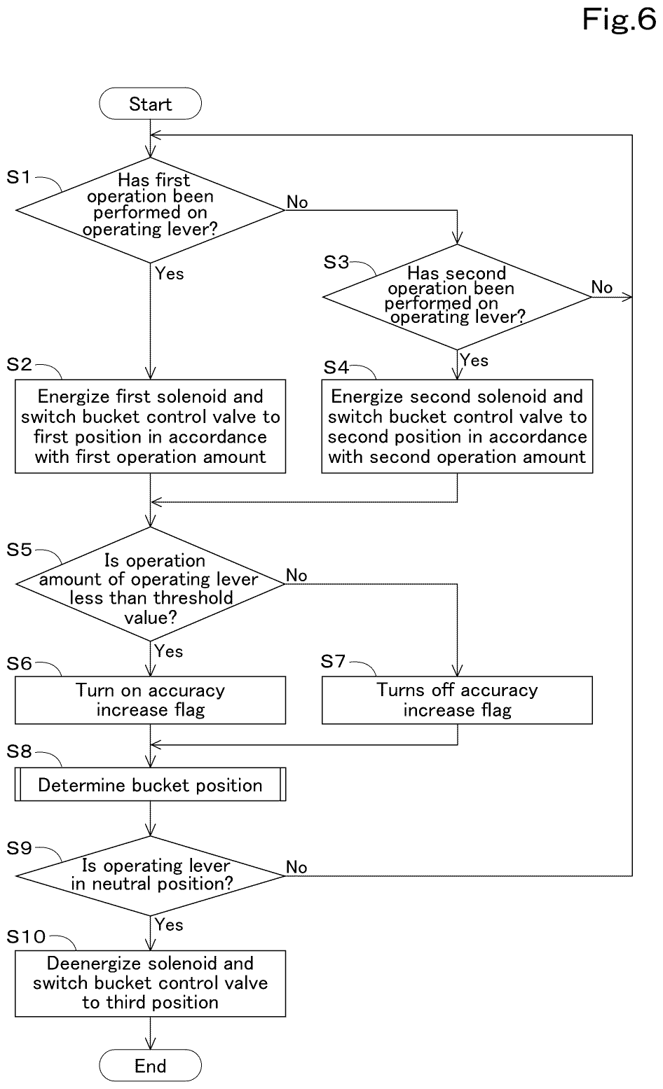

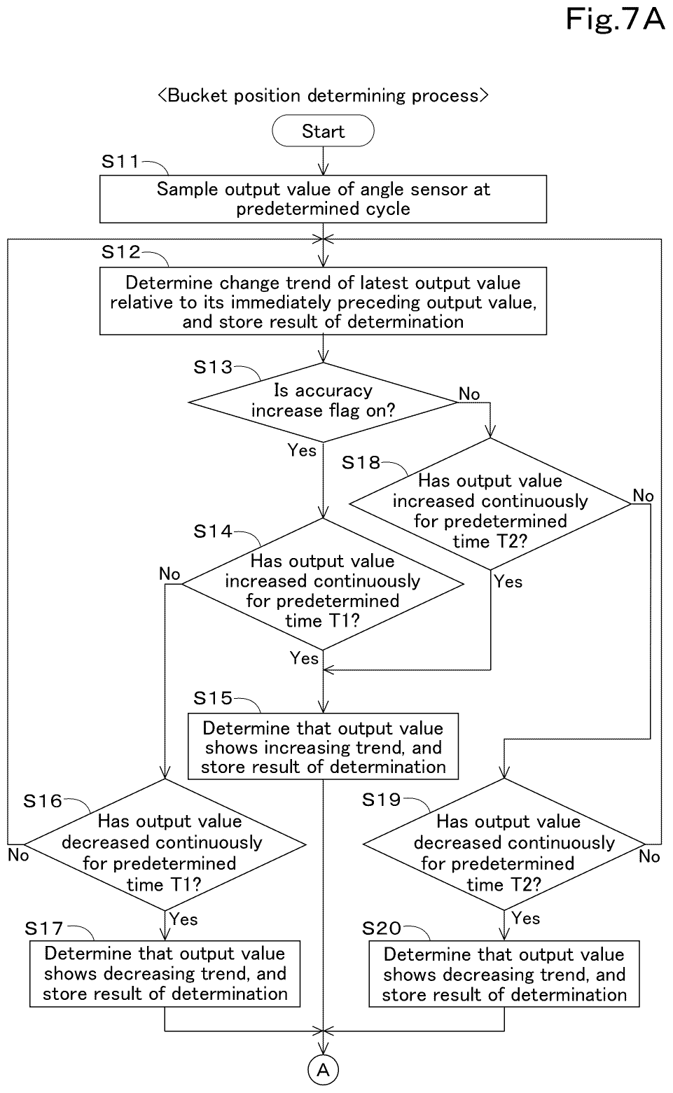

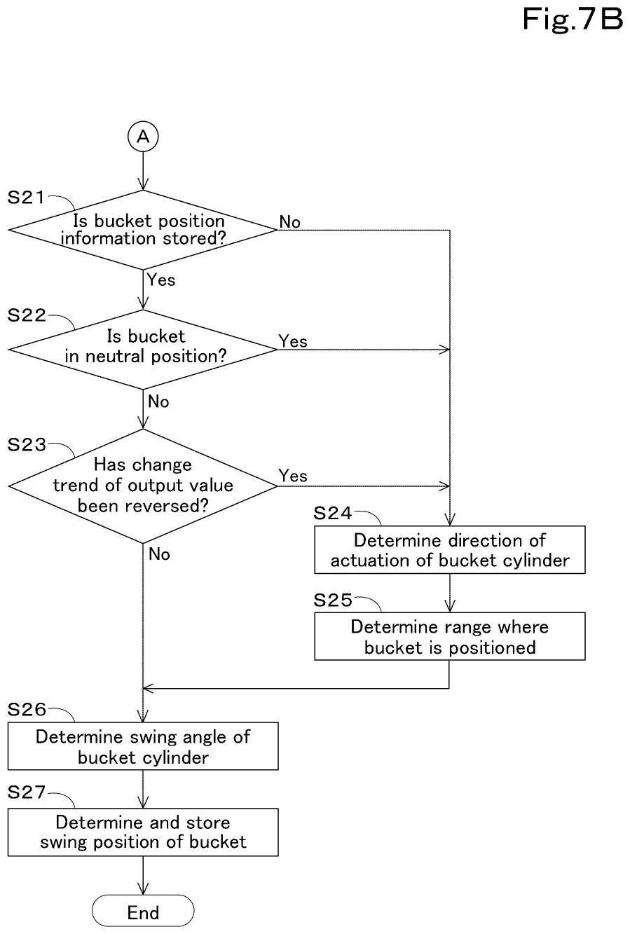

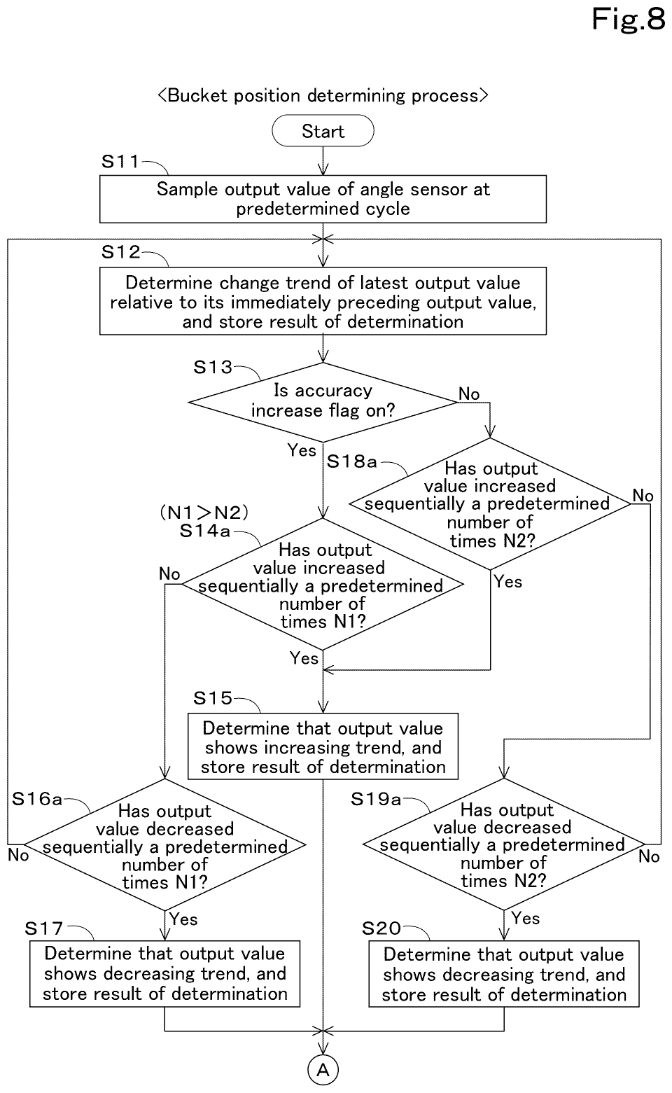

FIG. 6 is a flowchart illustrating an example of operation of the bucket control system of the working machine 1. FIGS. 7A and 7B are flowcharts illustrating details of a bucket swing position determining process of FIG. 6. The process of FIGS. 6 to 7B is performed in accordance with a software program stored in the storing unit 71a by the controller 71 (CPU) (the same applies to FIG. 8, which will be described later).

In a case where the first operation of the operating lever 76 is performed (S1: YES in FIG. 6, “Operation lever first/second operation amount” in FIG. 5), the controller 71 energizes the first solenoid 72d (FIG. 4) and switches the bucket control valve 72 to the first position 72a (S2 in FIG. 6, “Control valve opening” in FIG. 5). In a case where the second operation of the operating lever 76 is performed (S3: YES in FIG. 6, “Operation lever first/second operation amount” in FIG. 5), the controller 71 energizes the second solenoid 72e (FIG. 4) and switches the bucket control valve 72 to the second position 72b (S4 in FIG. 6, “Control valve opening” in FIG. 5).

During execution of the step S2 or S4 in FIG. 6, the controller 71 gradually increases an input current (control current) to the corresponding first solenoid 72d or second solenoid 72e from a low value in accordance with an operation direction and an operation amount of the operating lever 76 as described above, and thus sets the input current value to a target value Ag according to an operation amount at a time when the operation of the operating lever 76 is stopped (“Operation lever first/second operation amount”, “Control valve input current” in FIG. 5). Furthermore, the controller 71 compares the operation amount of the first operation or the second operation of the operating lever 76 and a predetermined threshold Xt read out from the storing unit 71a.

As the threshold Xt, an operation amount of the operating lever 76 detected when the bucket 24 is continuously swung in one direction without rattling in accordance with the first operation or the second operation of the operating lever 76 is set in advance by a manufacturer, a dealer, or the like of the working machine 1, for example. That is, the threshold Xt is a threshold unique to the working machine 1. In the example illustrated in FIG. 5, the threshold Xt is a value lower than an operation amount Xg at a time when the operation of the operating lever 76 is stopped. The operation amount of the first operation or the second operation of the operating lever 76 is an example of a physical quantity that changes as the operating lever 76 is operated and that is included in a condition based on which the accuracy of determining the swing position of the bucket 24 is changed (step S5 in FIG. 6).

In a case where the operation amount (a first operation amount or a second operation amount) of the operating lever 76 is less than the threshold Xt (S5: YES in FIG. 6), the controller 71 turns on an accuracy increase flag provided in a predetermined storage region of the storing unit 71a (S6). In a case where the operation amount of the operating lever 76 is equal to or larger than the threshold Xt (S5: NO), the controller 71 turns off the accuracy increase flag (S6). Then, the controller 71 performs a bucket position determining process (S8).

The accuracy increase flag is a flag for setting whether or not the controller 71 causes the accuracy of determining the swing position of the bucket 24 to be higher than usual in the bucket position determining process (S8). In a case where the accuracy increase flag is off, the controller 71 determines the swing position of the bucket 24 with usual accuracy, and in a case where the accuracy increase flag is on, the controller 71 determines the swing position of the bucket 24 with an accuracy higher than usual.

In the bucket position determining process illustrated in FIGS. 7A and 7B, the controller 71 first samples the output value (voltage value) of the angle sensor 81 at a predetermined cycle Ra (S11 in FIG. 7A, “Angle sensor output value detection” in FIG. 5). Furthermore, the controller 71 compares the latest output value and its immediately preceding (second latest) output value among a plurality of output values of the angle sensor 81 thus sampled to determine whether the change trend of the latest output value relative to its immediately preceding output value is an increasing trend or decreasing trend, and causes a result of the determination to be stored in the storing unit 71a (S12 in FIG. 7A).

Next, in a case where the accuracy increase flag is on (S13: YES), the controller 71 determines whether or not the output value of the angle sensor 81 is rising continuously for a predetermined first time period (sampling time) T1 and whether or not the output value of the angle sensor 81 is lowering continuously for the first time period T1. The first time period T1 is the time for determining the change trend of the output value of the angle sensor 81 with an accuracy higher than usual and is set longer than a second time (sampling time) T2 in steps S18 and S19, which will be described later (T1 and T2 in FIG. 5). The second time period T2 is the time for determining the change trend of the output value of the angle sensor 81 during a usual time. Since the sampling cycle Ra of the output value of the angle sensor 81 is constant, the number of output values of the angle sensor 81 sampled during the first time period T1 is larger than the number of output values of the angle sensor 81 sampled during the second time period T2. In the example of FIG. 5, the number of output values of the angle sensor 81 sampled during the first time period T1 is 6, whereas the number of output values of the angle sensor 81 sampled during the second time period T2 is 4.

In a case where the output value of the angle sensor 81 is not rising nor lowering continuously for the first time period T1 (S14: NO, S16: NO), the controller 71 determines the change trend of the latest output value relative to its immediately preceding output value among newly sampled plurality of output values of the angle sensor 81 and causes a result of the determination to be stored in the storing unit 71a (S12).

In a case where the output value of the angle sensor 81 has increased continuously for the first time period T1 (S14: YES), the controller 71 determines that the output value of the angle sensor 81 shows an increasing trend (“Output value change trend determination” in FIG. 5) and causes a result of the determination to be stored in the storing unit 71a (S15 in FIG. 7A). In a case where the output value of the angle sensor 81 has decreased continuously for the first time period T1 (S16: YES), the controller 71 determines that the output value of the angle sensor 81 shows a decreasing trend (“Output value change trend determination” in FIG. 5) and causes a result of the determination to be stored in the storing unit 71a (S17 in FIG. 7A).

On the other hand, in a case where the accuracy increase flag is off (S13: NO), the controller 71 determines whether or not the output value of the angle sensor 81 is rising continuously for the predetermined second time period T2 and whether or not the output value of the angle sensor 81 is lowering continuously for the second time period T2. In a case where the output value of the angle sensor 81 is not rising nor lowering continuously for the second time period T2 (S18: NO, S19: NO), the controller 71 determines the change trend of the latest output value relative to its immediately preceding output value among newly sampled plurality of output values of the angle sensor 81 and causes a result of the determination to be stored in the storing unit 71a (S12).

In a case where the output value of the angle sensor 81 has increased continuously for the second time period T2 (S18: YES), the controller 71 determines that the output value of the angle sensor 81 shows an increasing trend (“Output value change trend determination” in FIG. 5) and causes a result of the determination to be stored in the storing unit 71a (S15 in FIG. 7A). In a case where the output value of the angle sensor 81 has decreased continuously for the second time period T2 (S19: YES), the controller 71 determines that the output value of the angle sensor 81 shows a decreasing trend (“Output value change trend determination” in FIG. 5) and causes a result of the determination to be stored in the storing unit 71a (S20 in FIG. 7A).

Next, the controller 71 checks whether or not bucket position information indicative of the swing position of the bucket 24 is stored in the storing unit 71a. In a case where the bucket position information is stored in the storing unit 71a (S21: YES in FIG. 7B), the controller 71 checks whether or not the bucket position information indicates that the bucket 24 is provided at the neutral position P3.

In a case where the bucket position information does not indicate that the bucket 24 is provided at the neutral position P3 (S22: NO), the controller 71 checks whether or not the change trend of the output value of the angle sensor 81 has been reversed from one of the increasing trend and the decreasing trend to the other. In a case where the change trend of the output value of the angle sensor 81 has not been reversed from one of the increasing trend and the decreasing trend to the other (S23: NO), the controller 71 reads the bucket position information and checks in which of the dump range E1 and the shovel range E2 the bucket 24 is positioned.

On the other hand, for example, in a case where the bucket position information is not stored in the storing unit 71a, for example, because the bucket control system has been initialized by maintenance (S21: NO), the controller 71 determines the direction in which the bucket cylinder C5 is actuated (extended or retracted) based on the operation state of the operating lever 76 (S24). In a case where the bucket position information indicates that the bucket 24 is in the neutral position P3 (S22: YES) or in a case where the change trend of the output value of the angle sensor 81 has been reversed from one of the increasing trend and the decreasing trend to the other (S23: YES), the controller 71 determines the direction in which the bucket cylinder C5 is actuated (extended or retracted) based on the operation state of the operating lever 76 (S24).

In the step S24, for example, in a case where the first operation signal is output from the operation device 75 to the controller 71 in response to the first operation of the operating lever 76, the controller 71 determines that the direction of actuation of the bucket cylinder C5 is a retracting direction. In a case where the second operation signal is output from the operation device 75 to the controller 71 in response to the second operation of the operating lever 76, the controller 71 determines that the direction of actuation of the bucket cylinder C5 is an extending direction.

In another example, in a case where the change trend of the output value of the angle sensor 81 has been reversed from one of the increasing trend and the decreasing trend to the other (S23: YES), the controller 71 may determine that the bucket 24 is in the range E2 or E1 opposite to the range E1 or E2 indicated by the bucket position information, instead of performing the steps S24 and S25.

Next, the controller 71 determines in which of the dump range E1 and the shovel range E2 the bucket 24 is positioned based on the change trend of the output value of the angle sensor 81 and the direction of actuation of the bucket cylinder C5 (S25).

In the step S25, for example, in a case where the change trend of the output value of the angle sensor 81 is an increasing trend and the direction of actuation of the bucket cylinder C5 is an extending action, the controller 71 determines that the bucket 24 is in the dump range E1. In a case where the change trend of the output value of the angle sensor 81 is an increasing trend and the direction of actuation of the bucket cylinder C5 is a retracting direction, the controller 71 determines that the bucket 24 is in the shovel range E2. In a case where the change trend of the output value of the angle sensor 81 is a decreasing trend and the direction of actuation of the bucket cylinder C5 is an extending direction, the controller 71 determines that the bucket 24 is in the shovel range E2. In a case where the change trend of the output value of the angle sensor 81 is a decreasing trend and the direction of actuation of the bucket cylinder C5 is a retracting direction, the controller 71 determines that the bucket 24 is in the dump range E1.

Next, the controller 71 detects the swing angle of the bucket cylinder C5 based on the output value of the angle sensor 81 (S26, “Cylinder swing angle detection” in FIG. 5). In this step, for example, the controller 71 determines the swing angle of the bucket cylinder C5 corresponding to a latest output value among a detected plurality of output values of the angle sensor 81 by referring to a control table stored in advance in the storing unit 71a. In another example, for example, the controller 71 may calculate the swing angle of the bucket cylinder C5 by assigning the latest output value of the angle sensor 81 to an arithmetic expression stored in advance in the storing unit 71a.

Then, the controller 71 determines the swing position of the bucket 24 based on the swing angle of the bucket cylinder C5 and the range E1 or E2 where the bucket 24 is provided (“Bucket swing position determination” in FIG. 5) and causes a result of the determination to be stored in the storing unit 71a as the bucket position information (S27 in FIG. 7). In this case, for example, the controller 71 determines the swing angle of the bucket 24 based on the swing angle of the bucket cylinder C5 by referring to a control table stored in advance in the storing unit 71a. In another example, for example, the controller 71 may calculate the swing angle of the bucket 24 by assigning the swing angle of the bucket cylinder C5 to an arithmetic expression stored in advance in the storing unit 71a.

For example, in a case where the swing angle of the bucket cylinder C5 is θ1, the swing angle of the bucket 24 detected based on the swing angle θ1 is θ1a, and the bucket 24 is in the dump range E1, the controller 71 determines that the bucket 24 is in a position swung from the neutral position P3 in the direction toward the dump range E1 by the angle θ1a.

For example, in a case where the swing angle of the bucket cylinder C5 is θ2, the swing angle of the bucket 24 detected based on the swing angle θ2 is θ2a, and the bucket 24 is in the shovel range E2, the controller 71 determines that the bucket 24 is in a position swung from the neutral position P3 in the direction toward the shovel range E2 by the angle θ2a. Note that in a case where the bucket cylinder C5 is positioned at the reversal position Pm and the swing angle of the bucket cylinder C5 is maximum, the controller 71 determines that the bucket 24 is at the neutral position P3.

In another example, for example, the dump range E1 may be expressed by “− (minus)” and the shovel range E2 may be expressed by “+ (plus)”, and in a case where the swing angle of the bucket 24 is “θa”, the controller 71 may decide the swing position of the bucket 24 as “−θa” or “+θa” depending on whether the bucket 24 is in the range E1 or E2. In this case, in a case where the swing angle of the bucket cylinder C5 is 0°, the controller 71 may decide the swing angle and the swing position of the bucket 24 as “0°”.

When the bucket position determining process is completed as described above, the controller 71 checks the operation state of the operating lever 76. In a case where the operating lever 76 has not been operated to the neutral position (S9: NO in FIG. 6), the controller 71 performs the step S1 and subsequent steps again.

Then, in a case where the operating lever 76 has been operated to the neutral position (S9: YES), the controller 71 deenergizes the first solenoid 72d/second solenoid 72e and switches the bucket control valve 72 to the third position 72c (S10). This stops working of the bucket cylinder C5 and the bucket 24. Note that also in this case, the controller 71 may cause the change trend of the output value of the angle sensor 81 and the swing position of the bucket 24 to be stored in the storing unit 71a by performing the steps S12 to S27 in FIG. 7.

According to the above example embodiment, as illustrated in FIG. 5, immediately after the first operation or the second operation of the operating lever 76 is started, while the operation amount of the operating lever 76 is less than the threshold Xt, the time taken for the controller 71 to determine the change trend of the output value of the angle sensor 81 is a required time Ta. When the operation amount of the operating lever 76 is equal to or larger than the threshold Xt, the time taken for the controller 71 to determine the change trend of the output value of the angle sensor 81 is a required time Tb shorter than the required time Ta. That is, the required time Ta is longer than the required time Tb. While the operation amount of the operating lever 76 is less than the threshold Xt, the time taken for the controller 71 to determine the swing position of the bucket 24 is a required time Tc, and, when the operation amount of the operating lever 76 is equal to or larger than the threshold Xt, the time taken for the controller 71 to determine the swing position of the bucket 24 is a required time Td shorter than the required time Tc. That is, the required time Tc is longer than the required time Td.

As described above, in a case where the operation amount of the operating lever 76 is less than the threshold Xt, the controller 71 samples a larger number of output values of the angle sensor 81 and determines the change trend of the larger number of output values over a longer time (the required times T1, T2, Ta, and Tb in FIG. 5) than in a case where the operation amount is equal to or larger than the threshold Xt, and thus increases the accuracy of determining the swing position of the bucket 24. In other words, the accuracy of determining the swing position of the bucket 24 and the time required for the determination are in a trade-off relationship. Accordingly, depending on the state of the operating lever 76, the bucket cylinder C5, and the bucket 24, the controller 71 gives priority to the accuracy of determining the swing position of the bucket 24 while the operation amount of the operating lever 76 is less than the threshold Xt and gives priority to shortening the time required for the determination in a case where the operation amount is equal to or larger than the threshold Xt.

Although the controller 71 determines that the output value of the angle sensor 81 shows an increasing trend or decreasing trend in a case where the output value of the angle sensor 81 has increased or decreased continuously for the predetermined period T1 or T2 in the example embodiment of FIG. 7A, the first time period T1 and the second time period T2 may be different values (T1≠T2) or the first time period T1 and the second time period T2 may be the same value (T1=T2). Alternatively, the controller 71 may determine that the output value of the angle sensor 81 shows an increasing trend or decreasing trend if the output value of the angle sensor 81 has increased or decreased sequentially a predetermined number of times of sampling N1 or N2, for example, as in the example embodiment illustrated in FIG. 8.

Specifically, in FIG. 8, in a case where the accuracy increase flag is on (S13: YES), the controller 71 determines whether or not the output value of the angle sensor 81 has increased sequentially a predetermined first number of times N1 and whether or not the output value of the angle sensor 81 has decreased sequentially the first number of times of sampling N1. The first number of times of sampling N1 is the number of times of sampling for determining the change trend of the output value of the angle sensor 81 with accuracy higher than usual and is set equal to or larger than 2 larger than a second number of times of sampling N2 in steps S18a and S19a, which will be described later. The second number of times of sampling N2 is the number of times of sampling for determining the change trend of the output value of the angle sensor 81 during a usual time.

In a case where the output value of the angle sensor 81 rises continuously the first number of times of sampling N1 (S14a: YES), the controller 71 determines that the output value of the angle sensor 81 shows an increasing trend and causes a result of the determination to be stored in the storing unit 71a (S15). In a case where the output value of the angle sensor 81 lowers continuously the first number of times of sampling N1 (S16a: YES), the controller 71 determines that the output value of the angle sensor 81 shows a decreasing trend and causes a result of the determination to be stored in the storing unit 71a (S17).

On the other hand, in a case where the accuracy increase flag is off (S13: NO), the controller 71 determines whether or not the output value of the angle sensor 81 is rising continuously the predetermined second number of times of sampling N2 and whether or not the output value of the angle sensor 81 is lowering continuously the predetermined second number of times of sampling N2. In a case where the output value of the angle sensor 81 has increased continuously the second number of times of sampling N2 (S18a: YES), the controller 71 determines that the output value of the angle sensor 81 shows an increasing trend and causes a result of the determination to be stored in the storing unit 71a (S15). In a case where the output value of the angle sensor 81 has decreased continuously the second number of times of sampling N2 (S19a: YES), the controller 71 determines that the output value of the angle sensor 81 shows a decreasing trend and causes a result of the determination to be stored in the storing unit 71a (S20). Then, the controller 71 performs the step S21 and subsequent processes in FIG. 7B as described above.

Even according to the example embodiment of FIG. 8, in a case where the operation amount of the operating lever 76 is less than the threshold Xt, the controller 71 can sample a larger number of output values of the angle sensor 81 and determines the change trend of the large number of output values over a longer time than in a case where the operation amount is equal to or larger than the threshold Xt, and thus increases the accuracy of determining the swing position of the bucket 24. In other words, while the actuation amount of the bucket cylinder C5 is relatively small, the controller 71 can improve the accuracy of determining the swing position of the bucket 24 by increasing the number of sampled output values of the angle sensor 81 than in a case where the action amount is large to some degree. Note that in another example, the first number of times of sampling N1 and the second number of times of sampling N2 may be the same value (N1=N2) instead of making the first number of times of sampling N1 and the second number of times of sampling N2 different (N1≠N2).

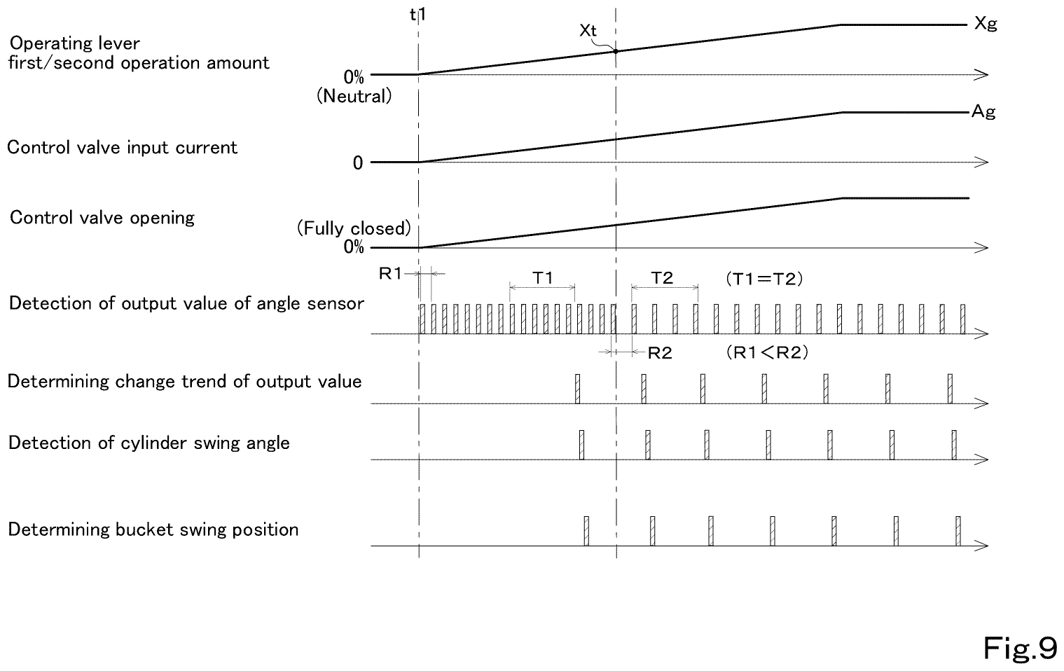

Although the controller 71 detects the output value of the angle sensor 81 on the constant cycle Ra as illustrated in FIG. 5 in the above example embodiment, the controller 71 may set the sampling time T1 used while the operation amount of the operating lever 76 is less than the threshold Xt and the sampling time T2 used while the operation amount is equal to or larger than the threshold Xt to the same value (T1=T2, that is, the sampling time is constant) and set a cycle R1 on which the output value of the angle sensor 81 is detected while the operation amount of the operating lever 76 is less than the threshold Xt shorter than a cycle R2 on which the output value of the angle sensor 81 is detected while the operation amount is equal to or larger than the threshold Xt (R1<R2, that is, R1≠R2), for example, as in the example embodiment illustrated in FIG. 9.

Even according to this example embodiment, in a case where the operation amount of the operating lever 76 is small and the action amount of the bucket cylinder C5 is small, the controller 71 can sample a larger number of output values of the angle sensor 81 than in a case where the operation amount of the operating lever 76 is large and the actuation amount of the bucket cylinder C5 is large, determine the change trend of the output value of the angle sensor 81 based on the large number of output values, and improve the accuracy of determining the swing position of the bucket 24. In the example of FIG. 9, the number of output values of the angle sensor 81 sampled in a case where the operation amount of the operating lever 76 is less than the threshold Xt is 6, whereas the number of output values of the angle sensor 81 sampled in a case where the operation amount of the operating lever 76 is equal to or larger than the threshold Xt is 4. In another example, both of the sampling time and the sampling cycle in a case where the operation amount of the operating lever 76 is less than the threshold Xt may be different from those in a case where the operation amount of the operating lever 76 is equal to or larger than the threshold Xt.

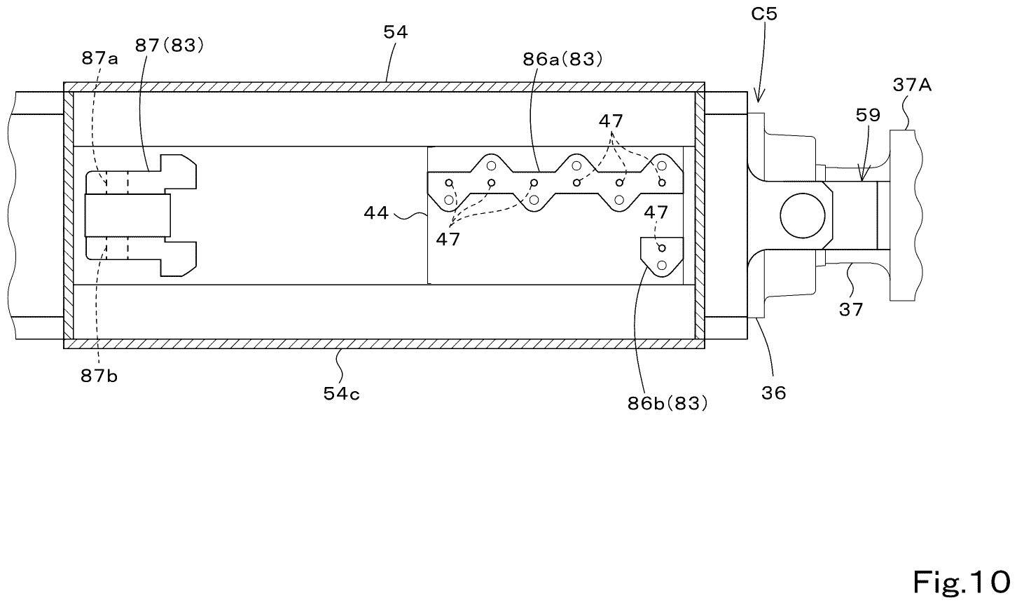

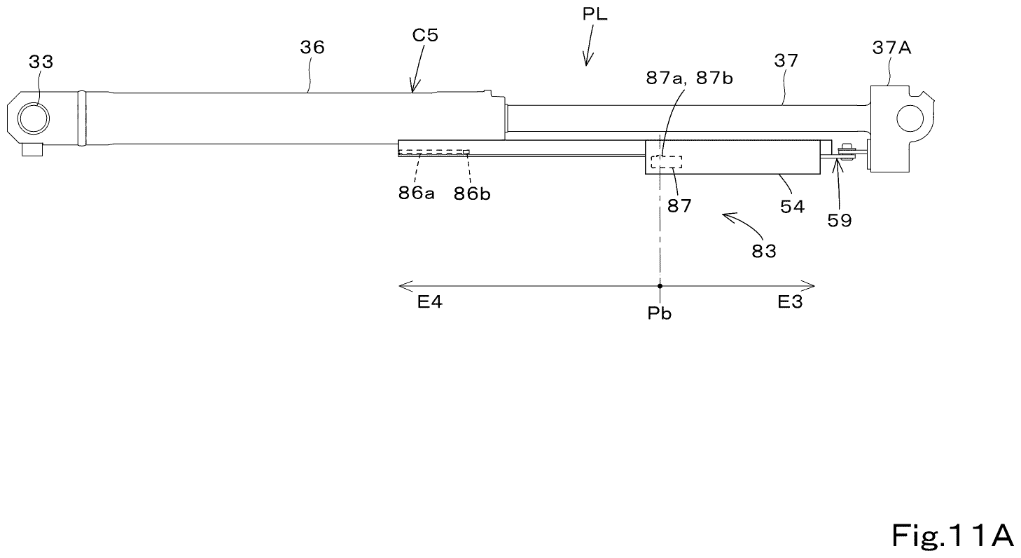

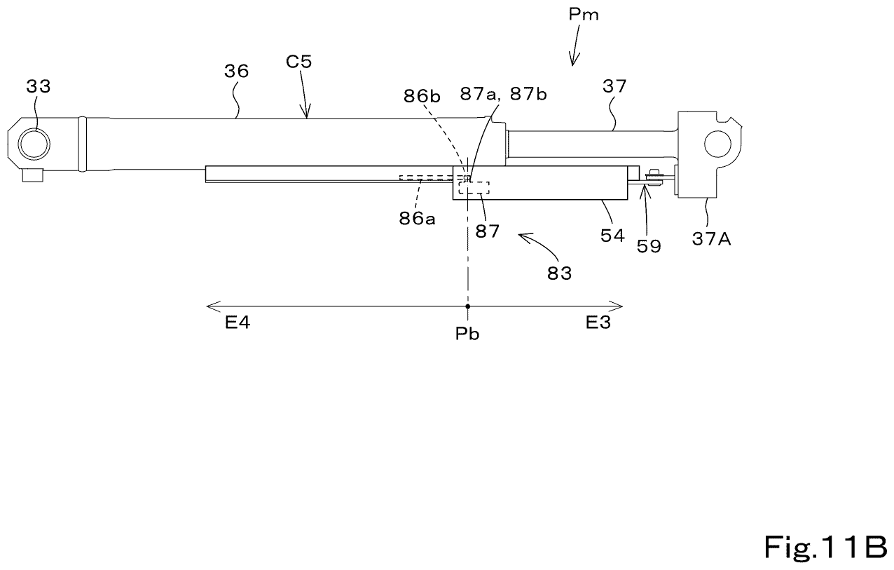

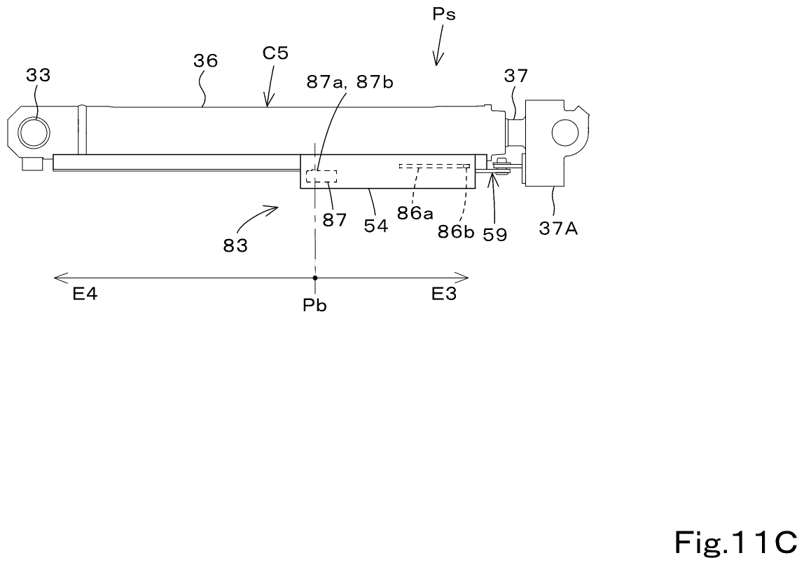

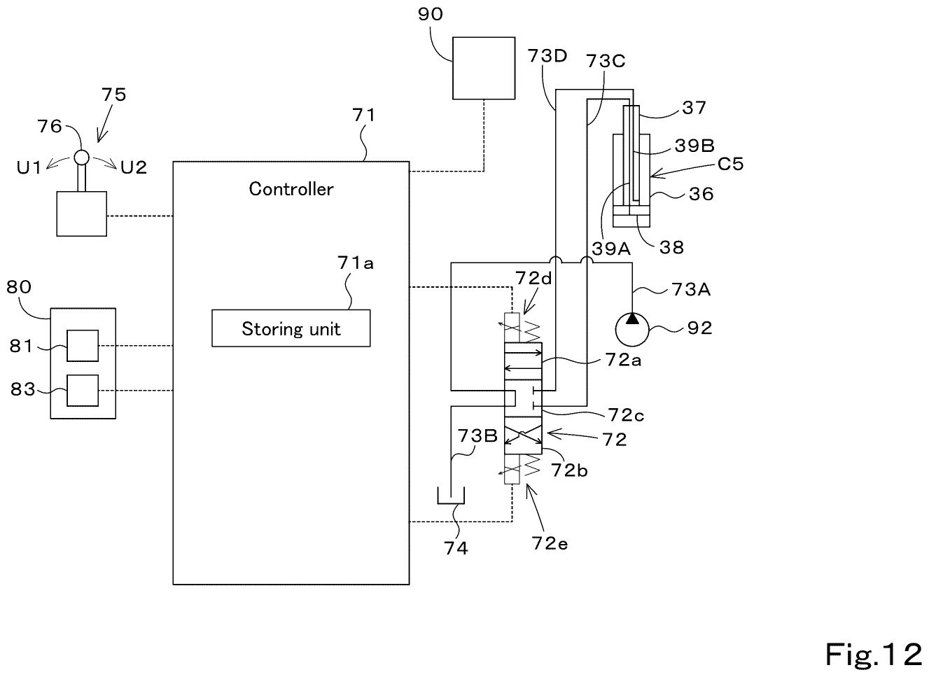

In the above example embodiment, the direction in which the bucket cylinder C5 is actuated (extended or retracted) is determined based on the operation state of the operating lever 76 in the step S24 of FIG. 7B. Alternatively, for example, as illustrated in FIGS. 10 and 11A to 11C, the position sensor 83 may be provided in the bucket cylinder C5 (the working machine 1), and the direction in in which the bucket cylinder C5 is actuated (extended or retracted) may be determined based on a detection signal output from the position sensor 83. As illustrated in FIG. 12, the position sensor 83 is included in the cylinder sensor 80.

As illustrated in FIGS. 10 and 11A to 11C, the position sensor 83 includes a first to-be-detected member 86a, a second to-be-detected member 86b, and a detector 87. The first to-be-detected member 86a and the second to-be-detected member 86b are fixed to the cylinder tube 36 of the bucket cylinder C5 with a plate 44 interposed therebetween. The first to-be-detected member 86a extends in a direction farther away from the head 37A than the second to-be-detected member 86b. The direction in which the first to-be-detected member 86a extends is parallel to the direction in which the bucket cylinder C5 extends.

The detector 87 is fixed to the rod 37 with a sensor case 54, a coupling member 59, and the like interposed therebetween. The detector 87 includes a first detection element 87a and a second detection element 87b. For example, the detection elements 87a and 87b are proximity sensors, and the members to be detected 86a and 86b are magnetic bodies in which a permanent magnet 47 (FIG. 19) is embedded. The first detection element 87a and the second detection element 87b are electrically connected to the controller 71. The first detection element 87a detects the first to-be-detected member 86a, and the second detection element 87b detects the second to-be-detected member 86b.

Note that the configuration of the detection elements 87a and 87b and the members to be detected 86a and 86b is not limited to that described above. For example, the detection elements 87a and 87b may be optical sensors, limit switches, or the like, and the members to be detected 86a and 86b may be detected by an element to be detected that can be detected by the detection elements 87a and 87b.

In a case where the rod 37 is a mobile body, the detection elements 87a and 87b detect the members to be detected 86a and 86b while moving together with the rod 37. In a case where the cylinder tube 36 is a mobile body, the detection elements 87a and 87b detect the members to be detected 86a and 86b that move together with the cylinder tube 36. In another example, the members to be detected 86a and 86b may be provided on the rod 37, and the detection elements 87a and 87b may be provided on the cylinder tube 36.

The detection elements 87a and 87b output, to the controller 71, an ON/OFF signal according to a position of the rod 37 relative to the cylinder tube 36 in a state where the bucket cylinder C5 has extended/retracted. Specifically, the detection elements 87a and 87b output an ON signal to the controller 71 while the detection elements 87a and 87b are detecting the members to be detected 86a and 86b. The detection elements 87a and 87b output an OFF signal to the controller 71 while the detection elements 87a and 87b are not detecting the members to be detected 86a and 86b. The ON/OFF signal of the detection elements 87a and 87b is, for example, a voltage signal, and a voltage value of the ON signal is set higher than that of the OFF signal.

In another example, the detection elements 87a and 87b may output an OFF signal while the detection elements 87a and 87b are detecting the members to be detected 86a and 86b, and the detection elements 87a and 87b may output an OFF signal while the detection elements 87a and 87b are not detecting the members to be detected 86a and 86b.

As illustrated in FIG. 11C, when the bucket cylinder C5 is at the fully retracted position Ps (fully retracted state), the detection elements 87a and 87b are positioned closer to the bottom side (side where the head 37A is not present) of the bucket cylinder C5 than the members to be detected 86a and 86b. Furthermore, both of the detection elements 87a and 87b are away from the members to be detected 86a and 86b and do not detect the members to be detected 86a and 86b, and output an ON signal.

As the bucket cylinder C5 extends from the fully retracted position Ps, first, the first detection element 87a detects the first to-be-detected member 86a and outputs an ON signal when the members to be detected 86a and 86b and the detection elements 87a and 87b pass by each other. Then, as illustrated in FIG. 11B, when the members to be detected 86a and 86b and the detection elements 87a and 87b are positioned at a reference position Pb, the second detection element 87b also detects the second to-be-detected member 86b and outputs an ON signal while the first detection element 87a continues to detect the first to-be-detected member 86a and output an ON signal.

When the first detection element 87a detects the first to-be-detected member 86a and the second detection element 87b detects the second to-be-detected member 86b, the bucket cylinder C5 is positioned at the reversal position Pm, and the bucket 24 is positioned at the neutral position P3 (FIG. 2). The reference position Pb corresponds to the reversal position Pm and the neutral position P3. When the bucket cylinder C5 further extends and the members to be detected 86a and 86b leave the detection elements 87a and 87b, both of the detection elements 87a and 87b cease to detect the members to be detected 86a and 86b and output an OFF signal.

As illustrated in FIG. 11A, also when the bucket cylinder C5 is at the fully extended position PL (fully extended state), both of the detection elements 87a and 87b are away from the members to be detected 86a and 86b and do not detect the members to be detected 86a and 86b, and output an OFF signal. As the bucket cylinder C5 retracts from the fully extended position PL and the members to be detected 86a and 86b and the detection elements 87a and 87b are positioned at the reference position Pb as illustrated in FIG. 11B, the first detection element 87a detects the first to-be-detected member 86a and outputs an ON signal, and the second detection element 87b also detects the second to-be-detected member 86b and outputs an ON signal.

When the bucket cylinder C5 further retracts, the second detection element 87b ceases to detect the second to-be-detected member 86b and outputs an OFF signal while the first detection element 87a continues to detect the first to-be-detected member 86a and output an ON signal. When the bucket cylinder C5 further retracts and the members to be detected 86a and 86b leave the detection elements 87a and 87b, both of the detection elements 87a and 87b cease to detect the members to be detected 86a and 86b and output an OFF signal.

As described above, the position sensor 83 detects on which of an extension range E4 and a retraction range E3 of the working tool cylinder C5 the members to be detected 86a and 86b that move as the working tool cylinder C5 extends and retracts are positioned with respect to the reference position Pb (FIG. 11B) corresponding to the neutral position P3 of the working tool 24, and outputs an ON/OFF signal in accordance with a state of the detection. The controller 71 determines the direction in which the bucket cylinder C5 is actuated (extended or retracted) based on a switching pattern of ON/OFF signals output from the detection elements 87a and 87b when the bucket cylinder C5 is working (extending/retracting and swinging) close to the reversal position Pm and the bucket 24 is working (swinging) close to the neutral position P3.

Specifically, the controller 71 determines that the direction of actuation of the bucket cylinder C5 is an extending direction in a case where, in a state where an OFF signal is input from the detection elements 87a and 87b, an ON signal is input from the first detection element 87a first and an ON signal is also input from the second detection element 87b next, and then an OFF signal is input from both of the detection elements 87a and 87b. The controller 71 determines that the direction of actuation of the bucket cylinder C5 is a retracting direction in a case where, in a state where an OFF signal is input from the detection elements 87a and 87b, an ON signal is input from both of the detection elements 87a and 87b, and then an OFF signal is input from the second detection element 87b first, and an OFF signal is also input from the first detection element 87a next.

The above configuration of the position sensor 83 is an example and is not restrictive. For example, a single detection element may be provided in the detector 87, both of the first to-be-detected member 86a and the second to-be-detected member 86b may be detected by this detection element, and the controller 71 may determine the direction in which the bucket cylinder C5 is actuated (extended or retracted) based on a fluctuation pattern of a voltage value of a detection signal output from the detection element.

Alternatively, for example, a plurality of members to be detected having different lengths may be arranged apart from one another in the extending direction of the bucket cylinder C5, the plurality of members to be detected may be detected by a single detection element, and the controller 71 may determine the direction in which the bucket cylinder C5 is actuated (extended or retracted) based on a fluctuation pattern of a voltage value of a detection signal output from the detection element.

Alternatively, as illustrated in FIGS. 10 and 11A to 11C, only the first to-be-detected member 86a and the first detection element 87a may be provided (the second to-be-detected member 86b and the second detection element 87b are omitted), and the controller 71 may determine the direction in which the bucket cylinder C5 is actuated (extended or retracted) based on a switching pattern of the ON/OFF signal of the first detection element 87a and the output value of the angle sensor 81. The other examples described above are also examples of the configuration of the position sensor and are not restrictive.

In the above example embodiment, in the step S25 of FIG. 7B, the controller 71 determines which of the ranges E1 and E2 the bucket 24 is positioned based on the direction of actuation of the bucket cylinder C5 and the change trend of the output value of the angle sensor 81. Alternatively, for example, as illustrated in FIG. 12, an input switch 85 for inputting the range E1 or E2 where the bucket 24 is provided may be included in the bucket control system (the working machine 1). In this case, the input switch 85 is provided close to the operator's seat 6 of the working machine 1 and is electrically connected to the controller 71.

For example, when the operator swings the bucket 24 to the dump range E1 by operating the operating lever 76 and the bucket 24 reaches the dump end position P1, the operator inputs information indicating that the bucket 24 is provided on the dump range E1 by operating the input switch 85. When the operator moves the bucket 24 to the shovel range E2 by operating the operating lever 76 and the bucket 24 reaches the shovel end position P2, the operator inputs information indicating that the bucket 24 is in the shovel range E2 by operating the input switch 85. The controller 71 causes the storing unit 71a to store the range E1 or E2 where the bucket 24 is provided thus input by the input switch 85.

In another example, the controller 71 may automatically recognize the range E1 or E2 where the bucket 24 is provided. For example, an output value of the angle sensor 81 at a time when the bucket 24 is at the dump end position P1 is set to a predetermined first voltage value, and an output value of the angle sensor 81 at a time when the bucket 24 is at the shovel end position P2 is set to a predetermined second voltage value different from the first voltage value. The controller 71 may determine that the bucket 24 is provided at the dump end position P1 when the output value of the angle sensor 81 matches the first voltage value and determine that the bucket 24 is provided at the shovel end position P2 when the output value of the angle sensor 81 matches the second voltage value, and cause a result of the determination to be stored in the storing unit 71a.

The controller 71 may determine the direction of actuation of the bucket cylinder C5 or the range E1 or E2 where the bucket 24 is provided by an appropriate combination of two or more of the operation state of the operating lever 76, the output value of the angle sensor 81, the ON/OFF signal of the position sensor 83, the input switch 85, and the automatic recognition of the range E1 or E2 where the bucket 24 is provided.

In the above example embodiment, the operation amount of the operating lever 76 is used as a physical quantity (a physical quantity for use in changing accuracy) that changes as the operating lever 76 is operated and that is included in the condition (step S5 in FIG. 6) based on which the accuracy of determining the swing position of the bucket 24 is changed. Alternatively, for example, a value of a control current (a value of an input current value) input to the corresponding solenoid 72d or 72e or a flow rate or a hydraulic pressure (an output value from the bucket control valve 72) of the hydraulic fluid flowing from the bucket control valve 72 to the bucket cylinder C5 when the bucket control valve 72 is switched to the first position 72a or the second position 72b may be employed as the physical quantity for changing accuracy.

In a case where the value of the control current input to the solenoid 72d or 72e is employed as the physical quantity for changing accuracy, the controller 71 compares the value of the control current to the solenoid 72d or 72e corresponding to operation of the operating lever 76 and a predetermined threshold At read out from the storing unit 71a when the bucket control valve 72 is switched to the first position 72a or the second position 72b (the step S2 or the step S4 in FIG. 6) in accordance with the first operation or the second operation of the operating lever 76. Then, instead of the step S5 of FIG. 6, the controller 71 turns on the accuracy increase flag when confirming that the value of the control current input to the solenoid 72d or 72e is less than the threshold At (S6). The controller 71 turns off the accuracy increase flag when confirming that the value of the control current input to the solenoid 72d or 72e is equal to or larger than the threshold At (S7).

As the threshold At, for example, a value of a current input to the first solenoid 72d or the second solenoid 72e that is measured when the bucket 24 is swung in one direction without rattling in accordance with the first operation or the second operation of the operating lever 76 may be set for each individual working machine 1 in advance by a manufacturer of the working machine 1. That is, the threshold At may be a unique threshold that is set to different values even for working machines 1 of the same model.

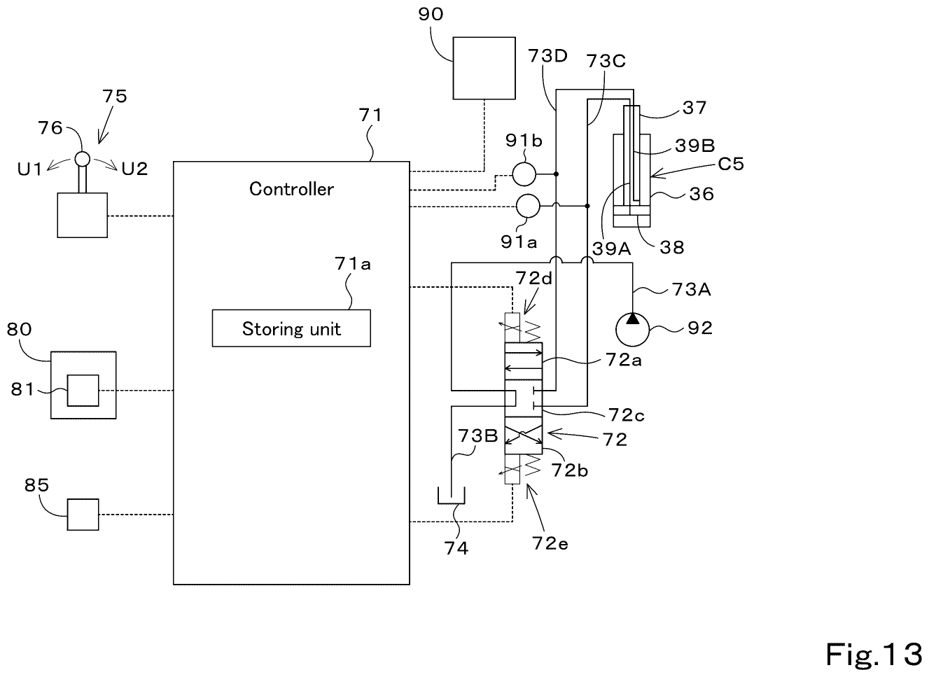

In a case where the flow rate of the hydraulic fluid from the bucket control valve 72 to the bucket cylinder C5 is employed as the physical quantity for changing accuracy, a first flow rate sensor 91a is provided on the first supply fluid passage 73C connected to the bucket control valve 72 and the bucket cylinder C5, and a second flow rate sensor 91b is provided on the second supply fluid passage 73D connected to the bucket control valve 72 and the bucket cylinder C5, for example, as illustrated in FIG. 13. When the bucket control valve 72 is switched to the first position 72a, the controller 71 measures a flow rate of the hydraulic fluid flowing from the bucket control valve 72 to the bucket cylinder C5 by the second flow rate sensor 91b. When the bucket control valve 72 is switched to the second position 72b, the controller 71 measures a flow rate of the hydraulic fluid flowing from the bucket control valve 72 to the bucket cylinder C5 by the first flow rate sensor 91a.

That is, the controller 71 measures the flow rate of the hydraulic fluid by the second flow rate sensor 91b after the step S2 illustrated in FIG. 6 or measures the flow rate of the hydraulic fluid by the first flow rate sensor 91a after the step S4, and compares the measured value with a predetermined threshold Zt stored in the storing unit 71a. Then, instead of the step S5, in a case where the measured value (the flow rate of the hydraulic fluid) is less than the threshold Zt, the accuracy increase flag is turned on (S6). In a case where the measured value is equal to or larger than the threshold Zt, the accuracy increase flag is turned off (S7). As the threshold Zt, for example, a flow rate of the hydraulic fluid from the bucket control valve 72 to the bucket cylinder C5 that is measured when the bucket 24 is swung in one direction without rattling in accordance with the first operation or the second operation of the operating lever 76 may be set for each individual working machine 1 in advance by a manufacturer or the like of the working machine 1. That is, the threshold Zt is a threshold unique to each individual working machine 1.

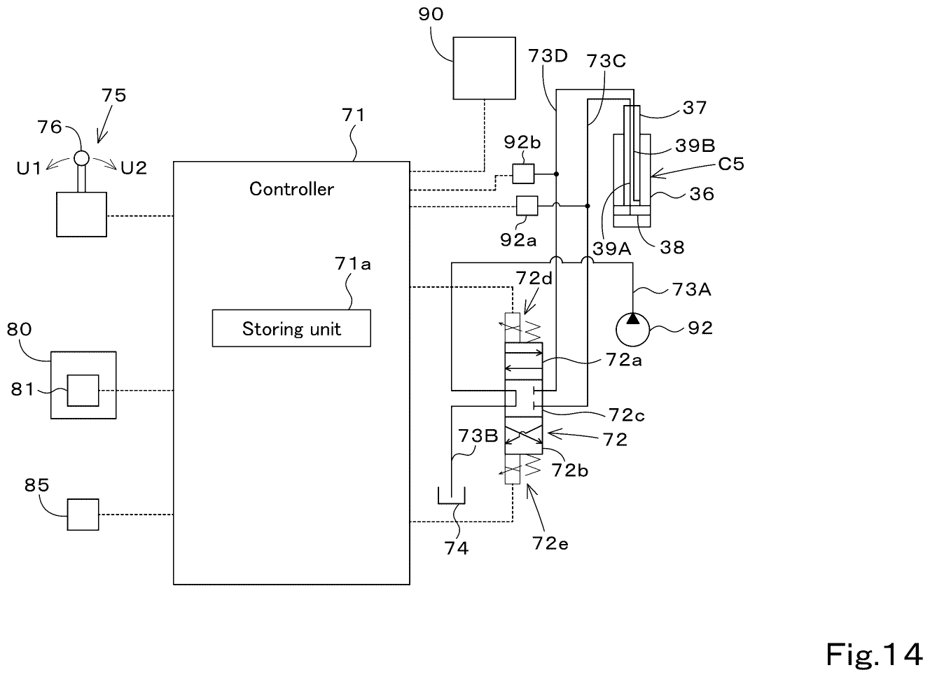

In a case where the hydraulic pressure of the hydraulic fluid from the bucket control valve 72 to the bucket cylinder C5 is employed as the physical quantity for changing accuracy, a first pressure sensor 92a is provided on the first supply fluid passage 73C connected to the bucket control valve 72 and the bucket cylinder C5, and a second pressure sensor 92b is provided on the second supply fluid passage 73D connected to the bucket control valve 72 and the bucket cylinder C5, for example, as illustrated in FIG. 14. When the bucket control valve 72 is switched to the first position 72a, the controller 71 measures the hydraulic pressure of the hydraulic fluid flowing from the bucket control valve 72 to the bucket cylinder C5 by the second pressure sensor 92b. When the bucket control valve 72 is switched to the second position 72b, the controller 71 measures the hydraulic pressure of the hydraulic fluid flowing from the bucket control valve 72 to the bucket cylinder C5 by the first pressure sensor 92a.

That is, the controller 71 measures the hydraulic pressure of the hydraulic fluid by the second pressure sensor 92b after the step S2 of FIG. 6 or measures the hydraulic pressure of the hydraulic fluid by the first pressure sensor 92a after the step S4, and compares the measured value with a predetermined threshold Zh stored in the storing unit 71a. Then, instead of the step S5, in a case where the measured value (the hydraulic pressure of the hydraulic fluid) is less than the threshold Zh, the accuracy increase flag is turned on (S6). In a case where the measured value is equal to or larger than the threshold Zh, the accuracy increase flag is turned off (S7). As the threshold Zh, for example, the hydraulic pressure of the hydraulic fluid from the bucket control valve 72 to the bucket cylinder C5 that is measured when the bucket 24 is swung in one direction without rattling in accordance with the first operation or the second operation of the operating lever 76 may be set for each individual working machine 1 in advance by a manufacturer or the like of the working machine 1. That is, the threshold Zh is a threshold unique to each individual working machine 1.

The employed physical quantity among the above candidates for the physical quantity for changing accuracy (the operation amount of the operating lever 76, the value of the control current input to the bucket control valve 72, and the flow rate and the hydraulic pressure of the hydraulic fluid from the bucket control valve 72 to the bucket cylinder C5) and the condition for changing accuracy including the employed physical quantity are stored in a nonvolatile memory included in the storing unit 71a. The physical quantity for changing accuracy and the condition for changing accuracy stored in the nonvolatile memory can be rewritten to another candidate for the physical quantity and a condition for changing accuracy including the physical quantity, for example, by a terminal device for rewriting, which is a personal computer or the like, by a manufacturer or the like.

The working machine 1 of the present example embodiment has the following configuration and produces the following effects.

A working machine 1 according to one or more example embodiments includes: an arm 23; a working tool (bucket) 24 swingably attached to the arm 23; a working tool cylinder (bucket cylinder) C5 to swing the working tool 24 by extending or retracting, one end portion of the working tool cylinder C5 being supported on the arm via a cylinder shaft, an opposite end portion of the working tool cylinder C5 being supported on the working tool 24; a cylinder sensor 80 to detect an operation of the working tool cylinder C5; a control valve (backet control valve) 72 to extend or retract the working tool cylinder C5 by controlling a flow of hydraulic fluid to the working tool cylinder C5; and a controller 71 configured or programmed to periodically determine a swing position of the working tool 24 based on an output value of the cylinder sensor 80, wherein the controller 71 is configured or programmed to change an accuracy of determining the swing position of the working tool 24 in accordance with an operating status of the working tool cylinder C5.

With the above configuration, the accuracy of determining the swing position of the working tool 24 by the controller 71 is not always the same but is changed in accordance with the operating status of the working tool cylinder C5, and therefore the swing position of the working tool 24 can be determined appropriately depending on the state of the working tool 24 which swings in accordance with the operating status of the working tool cylinder C5.

In one or more example embodiments, the control valve 72 may include a first solenoid 72d and a second solenoid 72e, and may be switchable between a first position 72a to retract the working tool cylinder C5, a second position 72b to extend the working tool cylinder C5, and a third position 72c to not extend or retract the working tool cylinder C5. The controller 71 may be configured or programmed to, when the control valve 72 is in the first position 72a or the second position 72b, cause the accuracy of determining the swing position of the working tool 24 to be higher than a predetermined determination accuracy for normal times until a predetermined condition is satisfied.

With the above configuration, the controller 71 causes the accuracy of determining the swing position of the working tool 24 to be higher than the determination accuracy for normal times until the predetermined condition is satisfied after the control valve 72 starts to be actuated, and therefore it is possible to prevent erroneous determination of the swing position of the working tool 24 even if a sufficiently high hydraulic pressure does not act from the control valve 72 on the working tool cylinder C5, the working tool cylinder C5 and the working tool 24 rattle due to an external force, and the output value of the cylinder sensor 80 irregularly fluctuates. Furthermore, after the predetermined condition is satisfied, the controller 71 does not increase the accuracy of determining the swing position of the working tool 24 anymore and determines the swing position of the working tool 24 with the determination accuracy for normal times, and therefore it is possible to prevent or reduce an increase in time required to determine the swing position of the working tool 24 and to properly determine the swing position of the working tool 24 while following the operation speed of the working tool 24 when a sufficiently high hydraulic pressure acts from the control valve 72 on the working tool cylinder C5 and the working tool cylinder C5 and the working tool 24 are stably operating as the control valve 72 is actuated. It follows that the working machine 1 can properly perform work via the working tool 24 based on the determined swing position of the working tool 24.

In one or more example embodiments, the working machine 1 may further include a manual operator (operating lever) to control a swing of the working tool cylinder C5. The controller 71 may be configured or programmed to, after the manual operator 76 starts to be operated and when the control valve 72 is in the first position 72a or the second position 72b, cause the accuracy of determining the swing position of the working tool 24 to be higher than the determination accuracy for normal times if an operation amount of the manual operator 76 is less than a predetermined threshold Xt, and set the accuracy of determining the swing position of the working tool 24 to the determination accuracy for normal times if the operation amount is equal to or larger than the threshold Xt.

With the above configuration, when the operation amount of the manual operator 76 is less than the threshold Xt after the start of operation of the manual operator 76, the controller 71 causes the accuracy of determining the swing position of the working tool 24 to be higher than usual, and therefore it is possible to properly determine the swing position even if a sufficiently high hydraulic pressure does not act on the working tool cylinder C5, the working tool cylinder C5 and the working tool 24 rattle, and the output value of the cylinder sensor 80 irregularly fluctuates. When the operation amount of the manual operator 76 is equal to or larger than the threshold Xt, the controller 71 determines the swing position of the working tool 24 with the accuracy for normal times, and therefore it is possible to properly determine the swing position of the working tool 24 while following the operation speed of the working tool 24 when a sufficiently high hydraulic pressure acts on the working tool cylinder C5 and the working tool cylinder C5 and the working tool 24 are stably operating.

In one or more example embodiments, the working machine 1 may further include a solenoid 72d, 72e to actuate the control valve in accordance with a supplied control current supplied from a controller 71. The controller 71 may be configured or programmed to, when the control valve 72 is in the first position 72a or the second position 72b, cause the accuracy of determining the swing position of the working tool to be higher than the determination accuracy for normal times if a control current value, which is a current value of the control current supplied to the solenoid, is less than a predetermined threshold At, and set the accuracy of determining the swing position of the working tool 24 to the determination accuracy for normal times if the control current value is equal to or larger than the threshold At.

With the configuration in which the control current value supplied to the solenoid 72d, 72e is gradually increased to the target value Ag to actuate the control valve 72, the opening of the control valve 72 is low and a sufficiently high hydraulic pressure does not act on the working tool cylinder C5 while the control current value is low. Therefore, in some cases, the working tool cylinder C5 and the working tool 24 rattle, and the output value of the cylinder sensor 80 irregularly fluctuates. However, when the value of the control current supplied to the solenoid 72d, 72e is less than the threshold At, the controller 71 causes the accuracy of determining the swing position of the working tool 24 to be higher than usual, and therefore it is possible to properly determine the swing position of the working tool 24 even if a sufficiently high hydraulic pressure does not act on the working tool cylinder C5, the working tool cylinder C5 and the working tool 24 rattle, and the output value of the cylinder sensor 80 irregularly fluctuates. Furthermore, when the value of the control current supplied to the solenoid 72d, 72e is equal to or larger than the threshold At, the controller 71 determines the swing position of the working tool 24 with the accuracy for normal times, and therefore it is possible to properly determine the swing position of the working tool 24 while following the operation speed of the working tool 24 when a sufficiently high hydraulic pressure acts on the working tool cylinder C5 and the working tool cylinder C5 and the working tool 24 are stably operating.

In one or more example embodiments, the working machine 1 may further include a flow rate sensor 91a, 91b to measure a flow rate of hydraulic fluid flowing from the control valve 72 to the working tool cylinder C5. The controller 71 may be configured or programmed to, when the control valve 72 is in the first position 72a or the second position 72b, cause the accuracy of determining the swing position of the working tool 24 to be higher than the determination accuracy for normal times if the flow rate of hydraulic fluid measured by the flow rate sensor 91a, 91b is less than a predetermined threshold Zt, and set the accuracy of determining the swing position of the working tool 24 to the determination accuracy for normal times if the flow rate of hydraulic fluid is equal to or higher than the threshold Zt.

With the above configuration, when the flow rate of the hydraulic fluid from the control valve 72 to the working tool cylinder C5 is less than the threshold Zt when the control valve 72 is actuated, the controller 71 causes the accuracy of determining the swing position of the working tool 24 to be higher than usual, and it is therefore possible to properly determine the swing position even if a sufficiently high hydraulic pressure does not act on the working tool cylinder C5, the working tool cylinder C5 and the working tool 24 rattle, and the output value of the cylinder sensor 80 irregularly fluctuates. When the flow rate of the hydraulic fluid from the control valve 72 to the working tool cylinder C5 is equal to or larger than the threshold Zt, the controller 71 determines the swing position of the working tool 24 with the accuracy for normal times, and therefore it is possible to properly determine the swing position of the working tool 24 while following the operation speed of the working tool 24 when a sufficiently high hydraulic pressure acts on the working tool cylinder C5 and the working tool cylinder C5 and the working tool 24 are stably operating.

In one or more example embodiments, the working machine 1 may further include a pressure sensor 92a, 92b to measure a hydraulic pressure of hydraulic fluid that acts from the control valve 72 on the working tool cylinder C5. The controller 71 may be configured or programmed to, when the control valve 72 is in the first position 72a or the second position 72b, cause the accuracy of determining the swing position of the working tool 24 to be higher than the determination accuracy for normal times if the hydraulic pressure of hydraulic fluid measured by the pressure sensor 92a, 92b is less than a predetermined threshold Zh, and set the accuracy of determining the swing position of the working tool 24 to the determination accuracy for normal times if the hydraulic pressure of hydraulic fluid is equal to or higher than the threshold Zh.

With the above configuration, while the hydraulic pressure of the hydraulic fluid from the control valve 72 to the working tool cylinder C5 is less than the threshold Zh when the control valve 72 is actuated, the controller 71 causes the accuracy of determining the swing position of the working tool 24 to be higher than usual, and therefore it is possible to properly determine the swing position even if a sufficiently high hydraulic pressure does not act on the working tool cylinder C5, the working tool cylinder C5 and the working tool 24 rattle, and the output value of the cylinder sensor 80 irregularly fluctuates. When the hydraulic pressure of the hydraulic fluid from the control valve 72 to the working tool cylinder C5 is equal to or higher than the threshold Zh, the controller 71 determines the swing position of the working tool 24 with the accuracy for normal times, and therefore it is possible to properly determine the swing position of the working tool 24 while following the operation speed of the working tool 24 when a sufficiently high hydraulic pressure acts on the working tool cylinder C5 and the working tool cylinder C5 and the working tool 24 are stably operating.

In one or more example embodiments, the controller 71 may be configured or programmed to change the accuracy of determining the swing position of the working tool 24 by changing the number of sampled output values of the cylinder sensor 80 used to determine the swing position of the working tool 24. This makes it possible to improve the accuracy of determining the swing position of the working tool 24 by increasing the number of sampled output values of the cylinder sensor 80.

In one or more example embodiments, the controller 71 may be configured or programmed to change the number of sampled output values of the cylinder sensor 80 by changing at least one of a sampling time T1, T2 or a sampling cycle R1, R2 during or at which the output value of the cylinder sensor 80 used to determine the swing position of the working tool 24 is sampled. This makes it possible to increase the number of sampled output values of the cylinder sensor 80, for example, by extending the sampling time T1 during which the output value of the cylinder sensor 80 is sampled and/or shortening the sampling cycle R1 in which the output value of the cylinder sensor 80 is sampled.

In one or more example embodiments, the working machine 1 may further include a machine body 2 to support the arm 23. The cylinder sensor 80 may include an angle sensor 81 to detect (i) a swing angle of the working tool cylinder C5 when the working tool 24 is in a range E1 (dumping range) farther away from the machine body 2 than a neutral position P3 of the working tool 24 and (ii) a swing angle of the working tool cylinder C5 when the working tool 24 is in a range (shoveling range) E2 closer to the machine body 2 than the neutral position of the working tool 24, the neutral position of the working tool 24 being a position in which the swing angle of the working tool cylinder C5 about the cylinder shaft 35 is maximum. The controller 71 may be configured or programmed to periodically detect the output value of the angle sensor 81 to determine a change trend of the output value, and determine the swing position of the working tool 24 based on the change trend of the output value, a direction of extension or retraction of the working tool cylinder C5, and the swing angle of the working tool cylinder C5 detected based on the output value of the angle sensor 81. This makes it possible to determine the swing position of the working tool 24 with high accuracy in the range E1 farther away from the machine body 2 and the range E2 closer to the machine body 2 even if the working tool 24 swings and passes through the neutral position P3 and the swing direction of the working tool cylinder C5 is reversed.

In one or more example embodiments, the controller 71 may be configured or programmed to determine that the output value of the angle sensor 81 shows an increasing trend if the output value has increased continuously for a predetermined period (first time period T1, second time period T2), determine that the output value of the angle sensor 81 shows a decreasing trend if the output value has decreased continuously for the predetermined period T1, T2, and change the predetermined period T1, T2 in accordance with the operating status of the working tool cylinder C5. This makes it possible to determine the swing position of the working tool 24 with high accuracy under conditions in which the output value of the angle sensor 81 is stably changing showing an increasing trend or decreasing trend. Furthermore, during the period from immediately after the start of actuation of the control valve 72 to when the predetermined condition is satisfied, it is possible to determine the change trend of the output value with higher accuracy and determine the swing position of the working tool 24 with higher accuracy based on a large number of sampled output values of the cylinder sensor 80 as compared to after the predetermined condition is satisfied.

In one or more example embodiments, the controller 71 may be configured or programmed to determine that the output value of the angle sensor 81 shows an increasing trend if the output value has increased sequentially a predetermined number of times (first number of times N1, second number of times N2) of sampling, determine that the output value of the angle sensor 81 shows a decreasing trend if the output value has decreased sequentially the predetermined number of times N1, N2 of sampling, and change the predetermined number of times of sampling N1, N2 in accordance with the operating status of the working tool cylinder C5. This makes it possible to determine the swing position of the working tool 24 with high accuracy under conditions in which the output value of the angle sensor 81 is stably changing showing an increasing trend or decreasing trend. Furthermore, during the period from immediately after the start of actuation of the control valve 72 to when the predetermined condition is satisfied, it is possible to determine the change trend of the output value with higher accuracy and determine the swing position of the working tool 24 with higher accuracy based on a large number of sampled output values of the cylinder sensor 80 as compared to after the predetermined condition is satisfied.

In one or more example embodiments, the working machine 1 may further include a manual operator 76 to control a swing of the working tool 24. The controller 71 may be configured or programmed to determine the direction in which the working tool cylinder C5 is actuated, based on an operation state of the manual operator 76. This makes it possible to reliably detect the direction in which the working tool cylinder C5 is actuated (extension or retraction of the working tool cylinder C5) according to operation of the manual operator 76. Furthermore, it is possible to determine the swing position of the working tool 24 with high accuracy in the range E1 farther away from the machine body 2 and in the range E2 closer to the machine body 2 based on the direction in which the working tool cylinder C5 is actuated, even if the working tool 24 swings and passes through the neutral position P3 and the swing direction of the working tool cylinder C5 is reversed.

In one or more example embodiments, the working machine 1 may further include a solenoid 72d, 72e to actuate the control valve 72 in accordance with a supplied control current supplied from a controller 71. The controller 71 may be configured or programmed to determine the direction in which the working tool cylinder C5 is actuated, based on a control current value which is a current value of the control current supplied to the solenoid 72d, 72e. This makes it possible to reliably detect the direction in which the working tool cylinder C5 was actually actuated (extension or retraction of the working tool cylinder C5) according to operation of the manual operator 76. Furthermore, it is possible to determine the swing position of the working tool 24 with high accuracy in the range E1 farther away from the machine body 2 and the range E2 closer to the machine body 2 based on the direction in which the working tool cylinder C5 is actuated, even if the working tool 24 swings and passes through the neutral position P3 and the swing direction of the working tool cylinder C5 is reversed.

In one or more example embodiments, the working machine 1 may further include a memory and/or a storage (storing unit) 71a to store, in a changeable manner, setting information relating to the predetermined condition based on which the accuracy of determining the swing position of the working tool 24 is changed. The controller 71 may be configured or programmed to decide the predetermined condition in accordance with the setting information stored in the memory and/or the storage 71a. This makes it possible to freely change the predetermined condition used to change the accuracy of determining the swing position of the working tool 24 by rewriting the setting information stored in the memory and/or storage 71a.

In one or more example embodiments, the setting information stored in the memory and/or the storage 71a may include a threshold unique to the working machine 1 and to be compared with a physical quantity which changes as the manual operator 76 is operated, the physical quantity being included in the predetermined condition based on which the accuracy of determining the swing position of the working tool 24 is changed. This makes it possible to change, for each working machine 1, the accuracy of determining the swing position of the working tool 24 based on the operating status of the working tool cylinder C5, and determine the swing position of the working tool 24 appropriately depending on the state of the working tool 24.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working machine comprising:
an arm;
a working tool swingably attached to the arm;
a working tool cylinder to swing the working tool by extending or retracting, one end portion of the working tool cylinder being supported on the arm via a cylinder shaft, an opposite end portion of the working tool cylinder being supported on the working tool;
a cylinder sensor to detect an operation of the working tool cylinder;
a control valve to extend or retract the working tool cylinder by controlling a flow of hydraulic fluid to the working tool cylinder; and
a controller configured or programmed to periodically determine a swing position of the working tool based on an output value of the cylinder sensor; wherein
the controller is configured or programmed to change an accuracy of determining the swing position of the working tool in accordance with an operating status of the working tool cylinder.

2. The working machine according to claim 1, wherein
the control valve is switchable between a first position to retract the working tool cylinder, a second position to extend the working tool cylinder, and a third position to not extend or retract the working tool cylinder; and
the controller is configured or programmed to, when the control valve is in the first position or the second position, cause the accuracy of determining the swing position of the working tool to be higher than a predetermined determination accuracy for normal times until a predetermined condition is satisfied.

3. The working machine according to claim 2, further comprising a manual operator to control a swing of the working tool cylinder; wherein
the controller is configured or programmed to, after the manual operator starts to be operated and when the control valve is in the first position or the second position:
cause the accuracy of determining the swing position of the working tool to be higher than the determination accuracy for normal times if an operation amount of the manual operator is less than a predetermined threshold; and
set the accuracy of determining the swing position of the working tool to the determination accuracy for normal times if the operation amount is equal to or larger than the threshold.

4. The working machine according to claim 2, further comprising a solenoid to actuate the control valve in accordance with a supplied control current; wherein
the controller is configured or programmed to, when the control valve is in the first position or the second position:
cause the accuracy of determining the swing position of the working tool to be higher than the determination accuracy for normal times if a control current value, which is a current value of the control current supplied to the solenoid, is less than a predetermined threshold; and
set the accuracy of determining the swing position of the working tool to the determination accuracy for normal times if the control current value is equal to or larger than the threshold.

5. The working machine according to claim 2, further comprising a flow rate sensor to measure a flow rate of hydraulic fluid flowing from the control valve to the working tool cylinder; wherein
the controller is configured or programmed to, when the control valve is in the first position or the second position:
cause the accuracy of determining the swing position of the working tool to be higher than the determination accuracy for normal times if the flow rate of hydraulic fluid measured by the flow rate sensor is less than a predetermined threshold; and
set the accuracy of determining the swing position of the working tool to the determination accuracy for normal times if the flow rate of hydraulic fluid is equal to or higher than the threshold.

6. The working machine according to claim 2, further comprising a pressure sensor to measure a hydraulic pressure of hydraulic fluid that acts from the control valve on the working tool cylinder; wherein
the controller is configured or programmed to, when the control valve is in the first position or the second position:
cause the accuracy of determining the swing position of the working tool to be higher than the determination accuracy for normal times if the hydraulic pressure of hydraulic fluid measured by the pressure sensor is less than a predetermined threshold; and
set the accuracy of determining the swing position of the working tool to the determination accuracy for normal times if the hydraulic pressure of hydraulic fluid is equal to or higher than the threshold.

7. The working machine according to claim 1, wherein
the controller is configured or programmed to change the accuracy of determining the swing position of the working tool by changing the number of sampled output values of the cylinder sensor used to determine the swing position of the working tool.

8. The working machine according to claim 7, wherein
the controller is configured or programmed to change the number of sampled output values of the cylinder sensor by changing at least one of a sampling time or a sampling cycle during or at which the output value of the cylinder sensor used to determine the swing position of the working tool is sampled.

9. The working machine according to claim 1, further comprising a machine body to support the arm; wherein
the cylinder sensor includes an angle sensor to detect (i) a swing angle of the working tool cylinder when the working tool is in a range farther away from the machine body than a neutral position of the working tool and (ii) a swing angle of the working tool cylinder when the working tool is in a range closer to the machine body than the neutral position of the working tool, the neutral position of the working tool being a position in which the swing angle of the working tool cylinder about the cylinder shaft is maximum; and
the controller is configured or programmed to determine the swing position of the working tool based on a change trend of an output value of the angle sensor, a direction of extension or retraction of the working tool cylinder, and the swing angle of the working tool cylinder detected based on the output value of the angle sensor.

10. The working machine according to claim 9, wherein
the controller is configured or programmed to:
determine that the output value of the angle sensor shows an increasing trend if the output value has increased continuously for a predetermined period;
determine that the output value of the angle sensor shows a decreasing trend if the output value has decreased continuously for the predetermined period; and
change the predetermined period in accordance with the operating status of the working tool cylinder.

11. The working machine according to claim 9, wherein
the controller is configured or programmed to:
determine that the output value of the angle sensor shows an increasing trend if the output value has increased sequentially a predetermined number of times of sampling;
determine that the output value of the angle sensor shows a decreasing trend if the output value has decreased sequentially the predetermined number of times of sampling; and
change the predetermined number of times of sampling in accordance with the operating status of the working tool cylinder.

12. The working machine according to claim 9, further comprising a manual operator to control a swing of the working tool, wherein
the controller is configured or programmed to determine the direction in which the working tool cylinder is actuated, based on an operation state of the manual operator.

13. The working machine according to claim 9, further comprising a solenoid to actuate the control valve in accordance with a supplied control current, wherein
the controller is configured or programmed to determine the direction in which the working tool cylinder is actuated, based on a control current value which is a current value of the control current supplied to the solenoid.

14. The working machine according to claim 2, further comprising a memory and/or a storage to store setting information relating to the predetermined condition in a changeable manner, wherein
the controller is configured or programmed to decide the predetermined condition in accordance with the setting information stored in the memory and/or the storage.

15. The working machine according to claim 14, further comprising a manual operator to control a swing of the working tool, wherein
the setting information includes a threshold unique to the working machine and to be compared with a physical quantity which changes as the manual operator is operated, the physical quantity being included in the predetermined condition based on which the accuracy of determining the swing position of the working tool is changed.
